(19) United States
(12) Patent Application Publication
(10) Pub. No.: US 2026/0004276 A1
(43) Pub. Date: Jan. 1, 2026

(54) SETTLEMENT SYSTEM, WEARABLE DEVICE, PROCESSING EXECUTION METHOD, AND INFORMATION STORAGE MEDIUM

(71) Applicant: Rakuten Group, Inc., Tokyo (JP)

(72) Inventors: Hana Suzuki, Tokyo (JP); Dhananjaya Byranayakanahalli Honnappa, Bangalore (IN); Sreenivasulu Maddala, Bangalore (IN); Vinaya Kumar, Bangalore (IN); Ankur Azad, Bangalore (IN); Shubham Sapra, Bangalore (IN); Mukesh Kumar, Bangalore (IN); Thayyiba Nasreen Purackaloth Siyad, Bangalore (IN); Mounika Boggala, Bangalore (IN); Rahul GangaReddy, Bangalore (IN); Sai Siddartha Vemula, Bangalore (IN)

(21) Appl. No.: 19/228,751

(22) Filed: Jun. 5, 2025

(30) Foreign Application Priority Data
Jun. 28, 2024 (JP) 2024-105254

(51) Int. Cl. G06Q 20/32; G06Q 20/38; G06Q 20/40

(52) U.S. Cl. CPC G06Q 20/3274; G06Q 20/321; G06Q 20/385; G06Q 20/4037

(57) ABSTRACT

A settlement system includes at least one processor that acquires setting information regarding settings related to a settlement service, the settings being designated on a user's portable terminal in the settlement service, and transmits the setting information to a wearable device that is connectable to the portable terminal.

### CROSS-REFERENCE TO RELATED APPLICATION

The present application claims priority from Japanese patent application JP2024-105254 filed on Jun. 28, 2024, the disclosures of which are incorporated by reference herein.

### BACKGROUND OF THE INVENTION

### 1. Field of the Invention

The present disclosure relates to a settlement system, a wearable device, a processing execution method, and an information storage medium.

### 2. Description of the Related Art

Hitherto, technology for allowing a user to use a settlement service from a wearable device that can be connected to the user's portable terminal is known. For example, JP 2021-039643 A discloses a display control system in which a user's portable terminal requests a server to issue a code to be used in a settlement service based on a token acquired in an authentication performed in advance, the server issues the code and transmits the code to the portable terminal, the portable terminal transmits the code to the wearable device, and the wearable device displays the code received from the portable terminal.

### SUMMARY OF THE INVENTION

However, the technology of PTL 1 displays the code on the wearable device and the wearable device cannot acquire settings related to the settlement service. Since the technology of PTL 1 requires the user to start up the mobile terminal and check the settings, it cannot sufficiently improve user convenience. An object of the present disclosure is to improve user convenience.

A settlement system according to the disclosure includes at least one processor that acquires setting information regarding settings related to a settlement service, the settings being designated on a user's portable terminal in the settlement service, and transmits the setting information to a wearable device that is connectable to the portable terminal.

### BRIEF DESCRIPTION OF THE DRAWINGS

FIG. 1 is a diagram showing an example of a hardware configuration of a settlement system;

FIG. 2 is a diagram showing an example of a screen displayed on a portable terminal;

FIG. 3 is a diagram showing an example of a screen displayed on a wearable device;

FIG. 4 is a diagram showing an example of a function implemented in a settlement system according to a first embodiment;

FIG. 5 is a diagram showing an example of an ID database;

FIG. 6 is a diagram showing an example of a settlement database;

FIG. 7 is a diagram showing an example of a process executed by the settlement system according to the first embodiment;

FIG. 8 is a diagram showing an example of a process executed by the settlement system according to the first embodiment;

FIG. 9 is a diagram showing an example of a screen displayed on a wearable device;

FIG. 10 is a diagram showing an example of a function implemented in a settlement system according to a second embodiment;

FIG. 11 is a diagram showing an example of a process executed by the settlement system according to the second embodiment;

FIG. 12 is a diagram showing an example of a function implemented in Modification Examples 1-1 to 1-3;

FIG. 13 is a diagram showing an example of usage restriction data;

FIG. 14 is a diagram showing an example of restriction release data;

FIG. 15 is a diagram showing an example of a hardware configuration in Modification Example 1-3;

FIG. 16 is a diagram showing an example of a screen displayed on a wearable device in Modification Example 1-3;

FIG. 17 is a diagram showing an example of a function implemented by a settlement system in Modification Examples 1-3 to 1-6;

FIG. 18 is a diagram showing an example of a point database;

FIG. 19 is a diagram showing an example of a function implemented in Modification Examples 2-1 to 2-7;

FIG. 20 is a diagram showing an example of a screen transition of a wearable device in Modification Example 2-3; and

FIG. 21 is a diagram showing an example of a screen displayed on a portable terminal in Modification Example 2-7.

### DETAILED DESCRIPTION OF THE INVENTION

### 1. First Embodiment

A first embodiment, which is an example of an embodiment of a settlement system, a wearable device, a display control method, and a program according to the disclosure, will be described.

### 1-1. Hardware Configuration of Settlement System

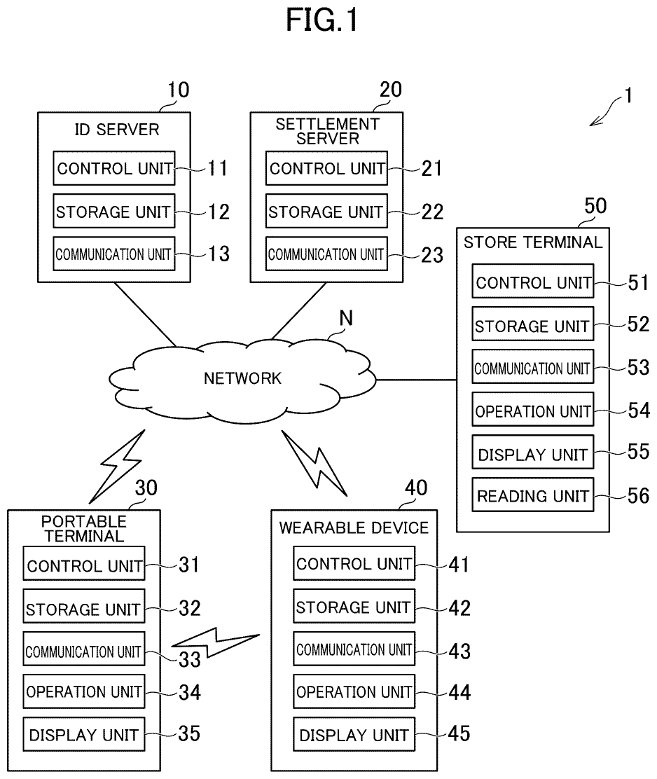

FIG. 1 is a diagram showing an example of a hardware configuration of a settlement system. For example, a settlement system 1 includes an ID server 10, a settlement server 20, a portable terminal 30, a wearable device 40, and a store terminal 50. Each of the ID server 10, the settlement server 20, the portable terminal 30, the wearable device 40, and the store terminal 50 is connected to a network N such as the Internet or a LAN. The number of each of the ID server 10, the settlement server 20, the portable terminal 30, the wearable device 40, and the store terminal 50 shown in FIG. 1 is one, but the number of at least one of the ID server 10, the settlement server 20, the portable terminal 30, the wearable device 40, and the store terminal 50 may be two or more.

The ID server 10 is a server computer that manages various information of users. For example, the ID server 10 includes a control unit 11, a storage unit 12, and a communication unit 13. The control unit 11 includes at least one processor. The storage unit 12 includes at least one of a volatile memory such as a RAM and a non-volatile memory such as a flash memory. The communication unit 13 includes at least one of a communication interface for wired communication and a communication interface for wireless communication.

The settlement server 20 is a server computer that provides a settlement service to users. The settlement service is a service that provides electronic settlement (cashless settlement) to users. For example, the settlement server 20 includes a control unit 21, a storage unit 22, and a communication unit 23. The hardware configurations of the control unit 21, the storage unit 22, and the communication unit 23 may be the same as those of the control unit 11, the storage unit 12, and the communication unit 13, respectively.

The portable terminal 30 is a mobile (portable) terminal. For example, the portable terminal 30 is a smartphone, a mobile phone not classified as a smartphone, a tablet, or a laptop. The portable terminal 30 may be a wearable device other than the wearable device 40. The portable terminal 30 includes a control unit 31, a storage unit 32, a communication unit 33, an operation unit 34, and a display unit 35. The hardware configurations of the control unit 31, the storage unit 32, and the communication unit 33 may be the same as those of the control unit 11, the storage unit 12, and the communication unit 13, respectively. The operation unit 34 is an input device such as a touch panel or a mouse. The display unit 35 is a display such as a liquid crystal or organic EL.

The wearable device 40 is a device that can be worn by a user. For example, the wearable device 40 may be a smart watch, smart glasses, or an accessory type device. The user can wear the wearable device 40 on any part of the body, such as the arm, finger, neck, or head. The wearable device 40 includes a control unit 41, a storage unit 42, a communication unit 43, an operation unit 44, and a display unit 45. The hardware configurations of the control unit 41, the storage unit 42, the communication unit 43, the operation unit 44, and the display unit 45 may be the same as those of the control unit 11, the storage unit 12, the communication unit 13, the operation unit 34, and the display unit 35, respectively. The wearable device 40 may include a SIM card that can be connected to a public communication line, or may be able to use wireless communication such as a wireless LAN without being connected to a public communication line.

The store terminal 50 is a terminal of an affiliated store that is affiliated with the settlement service. For example, the store terminal 50 is a POS terminal, a self-cash register terminal, a smartphone, a tablet, a handheld terminal, or a personal computer. The store terminal 50 includes a control unit 51, a storage unit 52, a communication unit 53, an operation unit 54, a display unit 55, and a reading unit 56. The hardware configurations of the control unit 51, the storage unit 52, the communication unit 53, the operation unit 54, and the display unit 55 may be the same as those of the control unit 11, the storage unit 12, the communication unit 13, the operation unit 34, and the display unit 35, respectively. The reading unit 56 is a reading device that reads a code to be described below. For example, the reading unit 56 is a camera, a scanner, a barcode reader, a two-dimensional code reader, or a reader/writer.

The programs stored in the storage units 12, 22, 32, 42, and 52 may be supplied to the ID server 10, the settlement server 20, the portable terminal 30, the wearable device 40, or the store terminal 50 via the network N. In addition, at least one of a reading unit (for example, a memory card slot) for reading a computer-readable information storage medium and an input/output unit (for example, a USB port) for inputting and outputting data to and from an external device may be provided in the ID server 10, the settlement server 20, the portable terminal 30, the wearable device 40, or the store terminal 50. For example, a program stored in an information storage medium may be supplied to the ID server 10, the settlement server 20, the portable terminal 30, the wearable device 40, or the store terminal 50 via at least one of the reading unit and the input/output unit.

Furthermore, the settlement system 1 may include at least one computer. The computer included in the settlement system 1 is not limited to the example in FIG. 1. For example, the settlement system 1 may include only the ID server 10 and the settlement server 20. In this case, the portable terminal 30, the wearable device 40, and the store terminal 50 exist outside the settlement system 1. The settlement system 1 may include only the settlement server 20. In this case, the ID server 10, the portable terminal 30, the wearable device 40, and the store terminal 50 exist outside the settlement system 1.

For example, the settlement system 1 may include only the settlement server 20, the portable terminal 30, and the wearable device 40. In this case, the ID server 10 and the store terminal 50 exist outside the settlement system 1. The settlement system 1 may include only the settlement server 20 and the wearable device 40. In this case, the ID server 10, the portable terminal 30, or the store terminal 50 exists outside the settlement system 1. For example, the settlement system 1 may include only the settlement server 20 and other computers not shown in FIG. 1.

### 1-2. Outline of First Embodiment

In the first embodiment, the user can use the settlement service from either the portable terminal 30 or the wearable device 40. The user can use any settlement means with the settlement service. The settlement means is a means used for settlement by the user. For example, the settlement means may be a credit card, electronic money, an account such as a bank account, points, cryptocurrency, a debit card, a wallet, or other means. Since codes such as barcodes or two-dimensional codes are also means for settlement, and equivalent to settlement means. A settlement means may also be used for payment, and thus it can also be referred to as a payment means.

For example, the portable terminal 30 stores a portable terminal application that allows the user to use the settlement service from the portable terminal 30. The portable terminal application is a settlement service application developed for the portable terminal 30. The portable terminal application may be distributed from a publicly known application store or from a website of a settlement service. When the user installs the portable terminal application on the portable terminal 30 and registers as a member of the settlement service, the user can use the settlement service from the portable terminal application. When the user completes the member registration and starts up the portable terminal application, the portable terminal 30 displays the screen of the portable terminal application on the display unit 35.

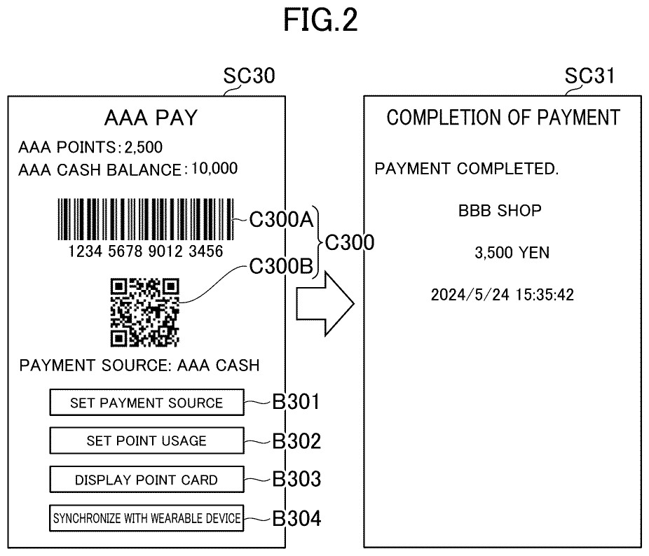

FIG. 2 is a diagram showing an example of a screen displayed on the portable terminal 30. For example, when the portable terminal application is started up, the portable terminal 30 temporarily displays a code screen SC30 on the display unit 35 as shown in a left part of FIG. 2, the code screen SC30 including a barcode C300A generated based on a code ID making it possible to temporarily identify a user, and a two-dimensional code C300B generated based on the code ID. Only one of the barcode C300A or the two-dimensional code C300B may be displayed on the code screen SC30. Hereinafter, when the barcode C300A and the two-dimensional code C300B are not distinguished from each other, they will be referred to as a code C300.

For example, when the code C300 is read by the reading unit 56 of the store terminal 50, a settlement for payment to an affiliated store is executed based on the code ID acquired from the code C300. A flow of the settlement may be the same as a flow of a known settlement service. When the settlement is completed, the portable terminal 30 displays a completion screen SC31 on the display unit 35 as shown in a right part of FIG. 2, the completion screen SC31 indicating that the payment to the affiliated store is completed.

A settlement method that can be used by the user in the settlement service is not limited to a method of causing the store terminal 50 to read the code C300. The settlement method may be any method. For example, the settlement method may be a type in which a code displayed on the store terminal 50 is read by the portable terminal 30, a type in which a code posted at an affiliated store is read by the portable terminal 30, a type that is completed only by operating the portable terminal 30, a type using an IC chip of the portable terminal 30, online settlement (for example, account settlement using a user's account, or ID settlement using the user's ID), carrier settlement which is settlement by a carrier used by the portable terminal 30, or other types.

For example, the user can change a payment source by selecting a button B301. The payment source is a settlement means that is used in payment to an affiliated store. In the example shown in the left part of FIG. 2, the payment source is online electronic money “AAA Cash”. The user can change the settings for using points in payments by selecting a button B302. The user can display at least one of a barcode and a two-dimensional code that serve as a point card by selecting a button B303. Details of the point card will be described in modification examples to be described below.

For example, the user can synchronize the portable terminal 30 and the wearable device 40 with each other by selecting a button B304. Details of the synchronization will be described later. The portable terminal 30 and the wearable device 40 may be synchronized automatically even when the user does not select the button B304. Once the synchronization of the portable terminal 30 and the wearable device 40 is completed, the user can use the settlement service from the wearable device 40.

For example, the wearable device 40 stores a wearable device application that allows the user to use a settlement service from the wearable device 40. The wearable device application is a settlement service application developed for the wearable device 40. The wearable device application may be distributed from a known application store or from the website of the settlement service.

For example, the portable terminal 30 executes a portable terminal application and the wearable device 40 executes a wearable device application, thereby synchronizing the portable terminal 30 and the wearable device 40. When the user installs the wearable device application on the wearable device 40 and synchronizes the portable terminal 30 and the wearable device 40 with each other, the user can use the settlement service from the wearable device application. Login from the wearable device application may be required in addition to login from the portable terminal application.

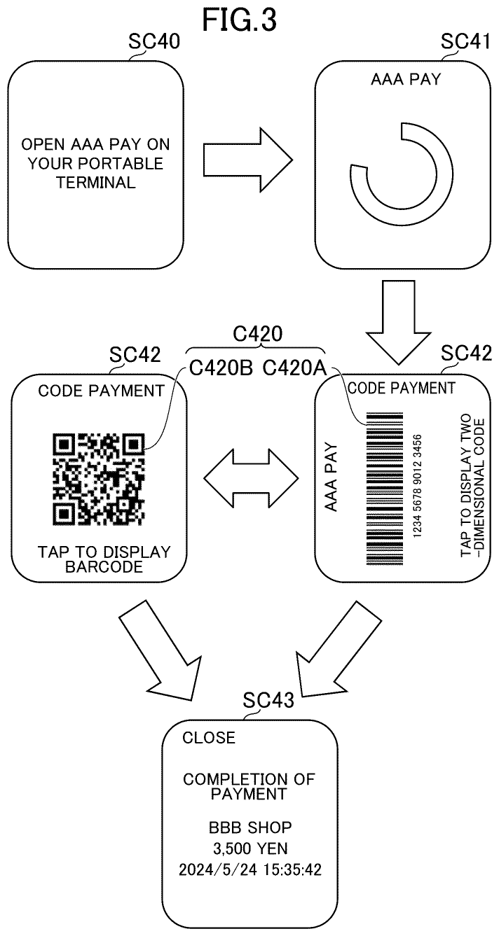

FIG. 3 is a diagram showing an example of a screen displayed on the wearable device 40. In FIG. 3, a case where the wearable device 40 is a smartwatch is exemplified. For example, when a wearable device application is started on the wearable device 40, the wearable device 40 displays a startup request screen SC40 on the display unit 45 as shown in the upper left part of FIG. 3, the startup request screen SC40 requesting the startup of a portable terminal application. When the portable terminal application is already started up, the startup request screen SC40 may not be displayed and synchronization may start automatically.

For example, when the portable terminal application is started up on the portable terminal 30, synchronization between the portable terminal 30 and the wearable device 40 is started. As shown in the upper right part of FIG. 3, the wearable device 40 displays a synchronization screen SC41 indicating that synchronization is in progress on the display unit 45. In this embodiment, a case where two pieces of information for authentication referred to as tokens are required for a user to use a settlement service from a wearable device application is exemplified, but one piece of authentication information or two or more pieces of authentication information may be required. Details of tokens will be described later. During synchronization, other processes besides token issuance may be executed.

For example, when synchronization between the portable terminal 30 and the wearable device 40 is completed, the wearable device 40 communicates with the settlement server 20 and displays a code screen SC42 including a barcode C420A generated based on a code ID on the display unit 45 as shown in the middle right part of FIG. 3. The barcode C420A may be the same as the barcode C300A, or at least a part of the barcode C420A may be different from the barcode C300A. For example, the barcode C420A may be different from the barcode C300A in the type of the barcode itself, the orientation, the size, or a combination thereof.

For example, when the user taps the wearable device 40 while the barcode C420A is displayed, the wearable device 40 displays a code screen SC42 including a two-dimensional code C420B generated based on a code ID on the display unit 45 as shown in the middle left part of FIG. 3. The wearable device 40 may acquire information required to display the two-dimensional code C420B from the settlement server 20 after the tapping, or may already acquire it from the settlement server 20 before the tapping.

For example, the two-dimensional code C420B may be the same as the two-dimensional code C300B, or at least a part of the two-dimensional code C420B may be different from the two-dimensional code C300B. The two-dimensional code C420B may be different from the two-dimensional code C300B in the type of the two-dimensional code itself, the orientation, the size, or a combination thereof. Hereinafter, when the barcode C420A and the two-dimensional code C420B are not distinguished from each other, they will be referred to as a code C420.

For example, when the code C420 is read by the store terminal 50, a settlement for payment to an affiliated store is executed based on the code ID acquired from the code C420. A flow of the settlement may be the same as a flow when a settlement is executed from a portable terminal application. When the settlement is completed, the wearable device 40 displays a completion screen SC43 on the display unit 45 as shown at the bottom of FIG. 3, the completion screen SC43 indicating that the payment to the affiliated store is completed.

In the first embodiment, the wearable device 40, not the portable terminal 30, mainly transmits a code display request for the display of the code C420 to the settlement server 20. The code display request is data in a predetermined format for requesting the display of the code C420. The code display request may be in any format, for example, in a format according to the API specifications of the settlement server 20. The code display request may include any information. An example of information that may be included in the code display request will be described below.

As described above, in the settlement system 1 of the first embodiment, the wearable device 40 mainly transmits the code display request to the settlement server 20, and thus the amount of processing performed by the portable terminal 30 to display the code C420 is reduced, thereby reducing a processing load of the portable terminal 30. Thereby, it is possible to prevent a failure in the display of the code C420 due to an increased processing load of the portable terminal 30, and thus user convenience can be improved. Details of the settlement system 1 will be described below.

### 1-3. Function Implemented by Settlement System According to First Embodiment

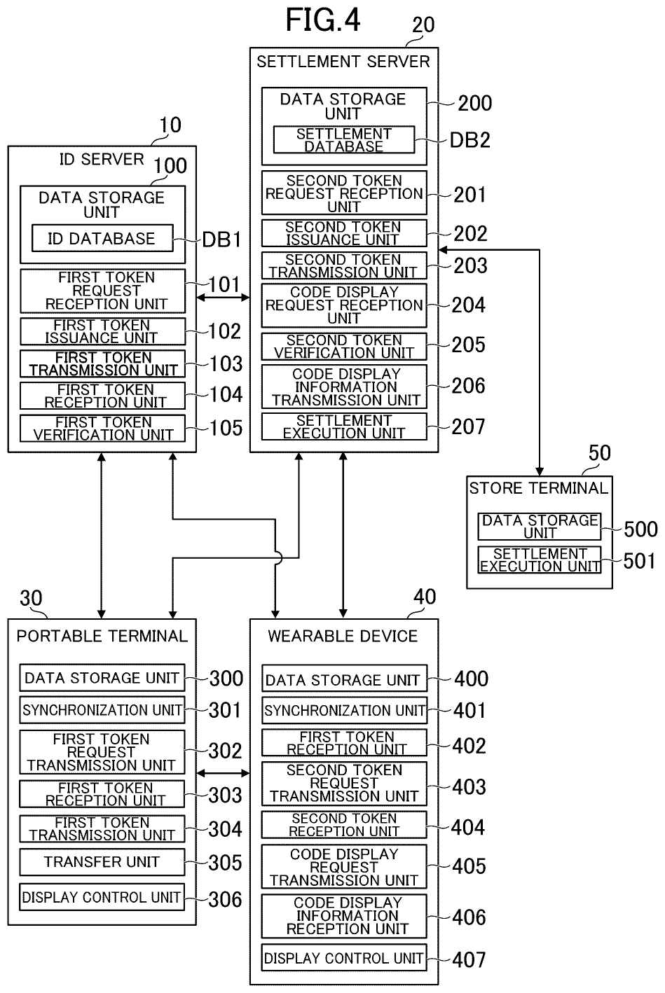

FIG. 4 is a diagram showing an example of a function implemented by the settlement system 1 according to the first embodiment. Parts implemented by the settlement system 1 can be configured by integrating them into one device or by distributing devices more finely.

### [1-3-1. Function Implemented by ID Server]

For example, the ID server 10 includes a data storage unit 100, a first token request reception unit 101, a first token issuance unit 102, a first token transmission unit 103, a first token reception unit 104, and a first token verification unit 105. The data storage unit 100 is implemented by the storage unit 12. Each of the first token request reception unit 101, the first token issuance unit 102, the first token transmission unit 103, the first token reception unit 104, and the first token verification unit 105 is implemented by the control unit 11.

### [Data Storage Unit]

The data storage unit 100 stores various information for each of a plurality of users. For example, the data storage unit 100 stores an ID database DB1.

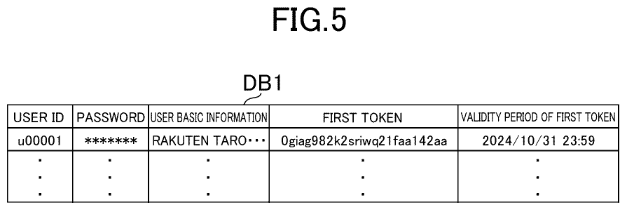

FIG. 5 shows an example of the ID database DB1. The ID database DB1 is a database for storing various information for each of a plurality of users. For example, the ID database DB1 stores a user ID, a password, user basic information, a first token, and a validity period of the first token. The ID database DB1 may store other information. For example, the ID database DB1 may store not only information regarding users in a settlement service, but also information regarding users in other services linked to the settlement service.

The user ID is an example of user identification information making it possible to identify a user. In addition to the user ID, there may be a login account for logging in to the settlement service. The login account may be freely changeable by the user. The login account is also an example of user identification information. For example, the user identification information may be information such as the user's email address, a telephone number, a portable terminal ID making it possible to identify the portable terminal 30, a wearable device ID making it possible to identify the wearable device 40, a random symbol issued by the ID server 10, or other information.

The code ID is also an example of user identification information because it is an ID making it possible to identify a user. The code ID is updated every time the code C300 or C420 is displayed. The code ID for the barcode C300A and the code ID for the two-dimensional code C300B may be the same or different. The code ID for the barcode C420A and the code ID for the two-dimensional code C420B may be the same or different.

The user identification information may also be information other than the user ID, the login account, and the code ID. The ID database DB1 may store the code ID. The password is information that is confirmed at the time of login. The user basic information is basic information regarding the user. For example, the user basic information indicates the user's name, gender, date of birth, email address, telephone number, address, or occupation. When there are services other than the settlement service, the user basic information may indicate a service that is being used by the user. The user ID may be common to the settlement service and other services.

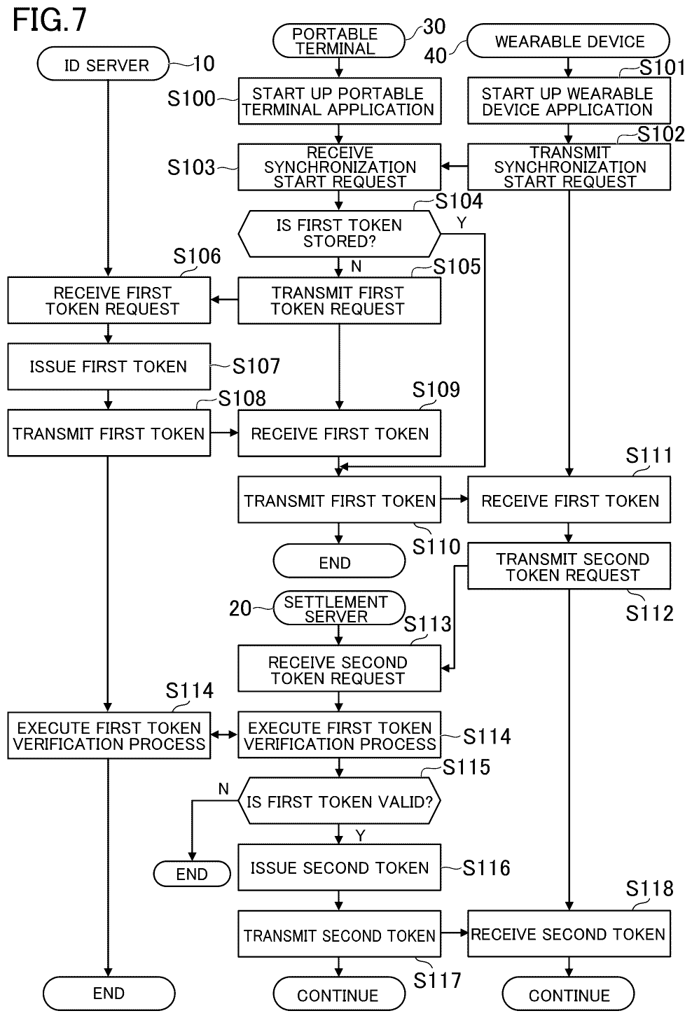

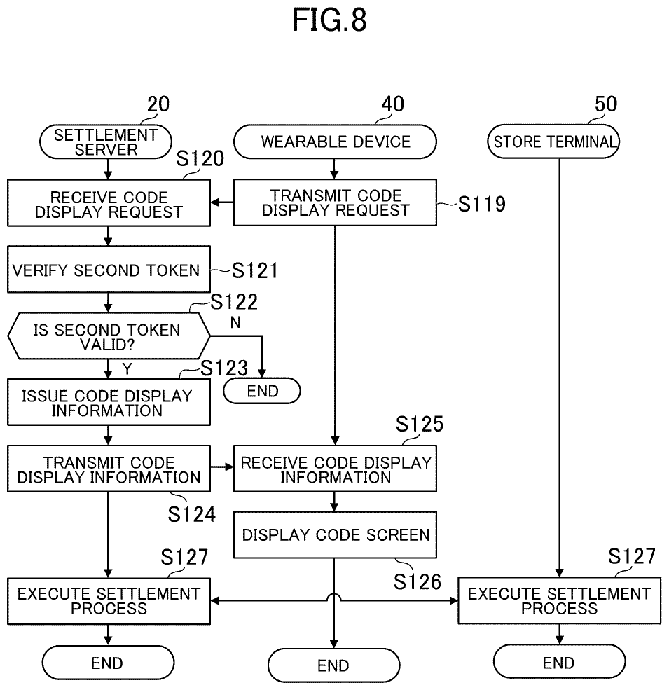

The first token is information used for authentication in the settlement service. For example, the first token may be letters, numbers, symbols, or a combination thereof. The first token may include an encrypted (hashed) user ID, or may not specifically include an encrypted user ID. The validity period of the first token is the date and time when a period during which the first token is valid ends. For example, the validity period of the first token is a validity period for a predetermined time (for example, 60 days) after the first token is issued. No particular validity period may be set for the first token. The first token may be valid semi-permanently unless the user instructs updating. The first token may be updated before the validity period of the first token ends. The first token may be updated when some process in the settlement system 1 (for example, any step in FIG. 7 and FIG. 8) is executed.

In the first embodiment, a case where the first token is used to issue a second token to be described later is exemplified. That is, a case where the first token is a token for proving the authority to issue the second token is exemplified. The first token may be used for purposes other than the issuance of the second token. For example, when the second token is not used by the user for a settlement service from the wearable device 40, the first token may be used by the user in authentication for a settlement service from the wearable device 40. In this case, the second token may not be provided. An aspect in which the second token is not provided is also within the scope of the disclosure. For example, the first token may be used to communicate with the settlement server 20. The first token may also be referred to as an exchange token for using a specific function or information of the settlement system 1.

The data stored in the data storage unit 100 is not limited to the ID database DB1. The data storage unit 100 may store data necessary for managing various information related to users. For example, the data storage unit 100 may store a program that indicates a process for verifying the first token. When the first token is not stored in the ID server 10, the data storage unit 100 may store data other than the program necessary for verifying the first token. These programs and data may be similar to the programs and data adopted in known tokens.

### [First Token Request Reception Unit]

The first token request reception unit 101 receives a first token request from a computer that transmits the first token request regarding the issuance of the first token. The first token request is data in a predetermined format for requesting the issuance of the first token. The first token request may be in any format and may be, for example, in a format according to the API specifications of the ID server 10. The first token request may include any information. For example, the first token request may include the portable terminal ID of the portable terminal 30, the wearable device ID of the wearable device, a user ID, an encrypted user ID, other information with which the user ID can be searched for, a login account, other information with which the account can be searched for, or other information.

For example, the first token request reception unit 101 receives the first token request directly or indirectly from the computer that transmits the first token request. The “directly” means that no other computer is involved. The “indirectly” means that another computer is involved. In the first embodiment, a case where the portable terminal 30 transmits the first token request is exemplified. For this reason, the first token request reception unit 101 receives the first token request directly or indirectly from the portable terminal 30. For example, when the settlement server 20 transfers the first token request from the portable terminal 30 to the ID server 10, the first token request reception unit 101 receives the first token request indirectly from the portable terminal 30.

In addition, a computer other than the portable terminal 30 may transmit the first token request. For example, the wearable device 40 may transmit the first token request. In this case, the first token request reception unit 101 receives the first token request directly or indirectly from the wearable device 40. In another example, the first token request reception unit 101 may receive the first token request from a computer other than the portable terminal 30 and the wearable device 40.

### [First Token Issuance Unit]

The first token issuance unit 102 issues a first token. The first token issuance unit 102 issues the first token based on a predetermined token issuance method. The program and data necessary for issuing the first token are assumed to be stored in the data storage unit 100. The first token issuance unit 102 issues the first token based on the program and the data. The token issuance method may be a known method. For example, the token issuance method may be an issuance method adopted in OAuth2.0 or JWT (JSON Web Token). The token issuance method may be a method of generating random symbols, letters, numbers, or a combination thereof.

For example, when the first token issuance unit 102 issues a first token for a certain user, the first token is stored in the ID database DB1 in association with the user ID of the user. The user ID may be included in the first token request. In this case, the first token issuance unit 102 specifies the user ID from the first token request. Instead of the user ID, other information (for example, a temporarily valid ID) with which the user ID can be searched for may be included in the first token request. In this case, the first token issuance unit 102 specifies the user ID from the other information. A relationship between the other information and the user ID is defined in the ID database DB1 or another database.

When a validity period is set for the first token, the first token issuance unit 102 determines the validity period of the first token. For example, the first token issuance unit 102 determines a point in time a predetermined time after the current time as the validity period of the first token. The first token issuance unit 102 stores the validity period in the ID database DB1 in association with the first token. For example, the first token issuance unit 102 may encrypt the user ID specified from the first token request and include the encrypted user ID in the first token. In this case, the first token issuance unit 102 may issue the encrypted user ID as the first token as it is, or may issue a first token including the encrypted user ID and other parts (for example, a part such as a random symbol, or a part in which basic information of the user is hashed). The encryption may be performed using a known encryption algorithm (for example, RSA encryption).

### [First Token Transmission Unit]

The first token transmission unit 103 transmits the first token to the computer that transmits the first token request. For example, the first token transmission unit 103 transmits the first token directly or indirectly to the computer that transmits the first token request. The meanings of the terms “directly” and “indirectly” are as described above. In the first embodiment, the portable terminal 30 transmits the first token request, and thus the first token transmission unit 103 transmits the first token to the portable terminal 30. When a computer other than the portable terminal 30 transmits the first token request, the first token transmission unit 103 may transmit the first token to the other computer.

When a validity period is set for the first token, the first token transmission unit 103 may transmit the first token and the validity period to the computer that transmits the first token request. The first token transmission unit 103 may not transmit the validity period to the computer that transmits the first token request. In this case, the validity period of the first token is managed by the ID server 10. Whether the first token has a validity period is determined by the ID server 10.

### [First Token Reception Unit]

Functions of the ID server 10 to be described below are functions related to verification of the first token. The first token reception unit 104 receives the first token from the computer that transmits the first token. For example, the first token reception unit 104 receives the first token directly or indirectly from the computer that transmits the first token. The meanings of the terms “directly” and “indirectly” are as described above. In the first embodiment, the wearable device 40 transmits the first token, and thus the first token reception unit 104 receives the first token from the wearable device 40. Furthermore, the wearable device 40 transmits the first token after synchronizing with the portable terminal 30, and thus the first token reception unit 104 receives the first token from the wearable device 40 that is synchronized with the portable terminal 30.

In the first embodiment, the wearable device 40 transmits the first token to the settlement server 20, and the settlement server 20 requests the ID server 10 to verify the first token. Thus, the first token reception unit 104 indirectly receives the first token from the wearable device 40 via the settlement server 20. That is, the first token reception unit 104 receives the first token transferred by the settlement server 20. The first token reception unit 104 may receive the first token from a computer other than the wearable device 40. For example, when the portable terminal 30 transmits the first token, the first token reception unit 104 may receive the first token from the portable terminal 30.

### [First Token Verification Unit]

The first token verification unit 105 verifies the first token received from the wearable device 40. Verification of the first token is to confirm the validity of the first token. The first token verification unit 105 verifies the first token based on a predetermined token verification method. The token verification method may be a known method. For example, the token verification method may be a verification method adopted in OAuth2.0 or JWT.

For example, when the first token verification unit 105 verifies a first token of a certain user, the first token verification unit 105 determines whether the first token received by the first token reception unit 104 is stored in the ID database DB1 in association with the user ID of the user. When the first token verification unit 105 determines that the first token is not stored in the ID database DB1 in association with the user ID, the first token verification unit 105 determines that the first token is not valid. When the first token verification unit 105 determines that the first token is stored in the ID database DB1 in association with the user ID, the first token verification unit 105 determines that the first token is valid.

The user ID may be included in the first token request. In this case, the first token verification unit 105 specifies the user ID from the first token. When the user ID is encrypted and included in the first token, the first token verification unit 105 decrypts the encrypted user ID included in the first token. The decryption may be performed by a known decryption algorithm (for example, RSA encryption). Instead of the user ID, other information with which the user ID can be searched for (for example, an ID with which a user can be temporarily identified) may be included in the first token. In this case, the first token verification unit 105 specifies the user ID from the other information. A relationship between the other information and the user ID is defined in the ID database DB1 or another database. The user ID or the other information may be data separate from the first token. In this case, the first token reception unit 104 may receive the user ID or the other information together with the first token.

Furthermore, when a validity period is set for the first token, the first token verification unit 105 may determine whether the first token within the validity period is received from the wearable device 40. The first token verification unit 105 may perform this determination based on the validity period stored in the ID database DB1, or may perform this determination based on the validity period received together with the first token. The first token verification unit 105 determines that the first token is not valid when the first token is not within the validity period. The first token verification unit 105 may verify the first token by determining whether the first token is stored in the ID database DB1, regardless of the user ID in particular.

### [1-3-2. Function Implemented by Settlement Server]

For example, the settlement server 20 includes a data storage unit 200, a second token request reception unit 201, a second token issuance unit 202, a second token transmission unit 203, a code display request reception unit 204, a second token verification unit 205, a code display information transmission unit 206, and a settlement execution unit 207. The data storage unit 200 is implemented by the storage unit 22. Each of the second token request 1 reception unit 201, the second token issuance unit 202, the second token transmission unit 203, the code display request reception unit 204, the second token verification unit 205, the code display information transmission unit 206, and the settlement execution unit 207 is implemented by the control unit 21.

### [Data Storage Unit]

The data storage unit 200 stores data required for a settlement service. For example, the data storage unit 200 stores a settlement database DB2.

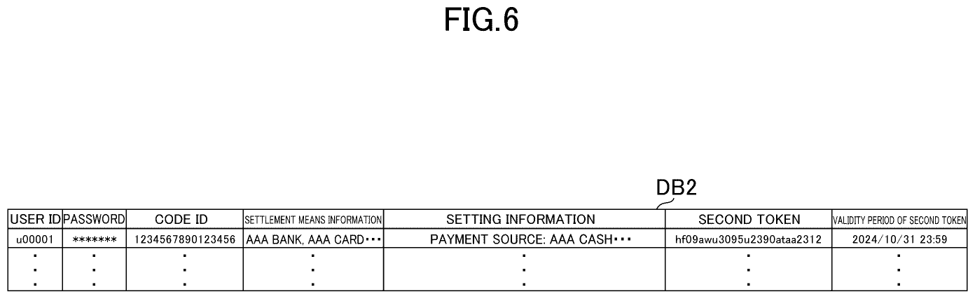

FIG. 6 is a diagram showing an example of the settlement database DB2. The settlement database DB2 is a database in which various information for each of a plurality of users is stored. For example, the settlement database DB2 stores a user ID, a password, a code ID, settlement means information, setting information, a second token, and a validity period of the second token. The settlement database DB2 may also store other information. For example, the settlement database DB2 may store usage history information regarding the usage history of the settlement service, a portable terminal ID, a wearable device ID, or a first token.

In the first embodiment, a case where a user ID of a certain user stored in the settlement database DB2 is the same as the user ID of the user stored in the ID database DB1 is described, but these user IDs may be different from each other. When these user IDs are different from each other, a relationship database indicating a relationship between the user ID stored in the settlement database DB2 and the user ID stored in the ID database DB1 is stored in the data storage unit 200. The relationship database may be stored in the data storage unit 100 of the ID server 10, in a computer other than the ID server 10 and the settlement server 20, or in an external information storage medium.

The settlement means information is information with which a user can identify a settlement means that can be used in a settlement service. The settlement means indicated by the settlement means information can be considered as a settlement means that is a candidate for a payment source. For example, the settlement means information is information such as a credit card number, information such as an electronic money number, information such as a bank account, or information such as a point card number. When a card is equivalent to a settlement means, the settlement means information may also include information making it possible to identify a card company that issued the card. The settlement means indicated in the settlement means information may be used not only for a payment source but also for other purposes such as a charging source of electronic money.

The setting information is information related to the settings designated by the user. For example, the setting information indicates a payment source designated by the user. In the example shown in FIG. 2, since the user designates electronic money as a payment source, the setting information indicates that the payment source is electronic money. When the user designates another settlement means, such as a credit card, as a payment source, the setting information indicates that the payment source is a credit card. The setting information may also indicate settings other than a payment source. For example, the setting information may indicate the setting of a charging source, which is a settlement means used to charge electronic money by the user, the setting of whether points can be applied, the setting of a settlement means preferentially used by the user among a plurality of settlement means (for example, the setting of one which is preferentially used by the user out of electronic money and points), the balance of electronic money, the number of points, validity periods of these, a maximum amount of settlement means, or other settings.

In the first embodiment, a case is exemplified in which, when the user performs an operation of changing setting information from a portable terminal application of the portable terminal 30 (for example, selects the button B304), the setting information associated with the user ID of the user is updated. Furthermore, a case is exemplified in which the user cannot change the setting information from the wearable device 40. The user may be able to change the setting information from the wearable device 40. In this case, the settlement server 20 may acquire change contents of the setting information designated by the user from the wearable device 40, and may change the setting information associated with the user ID of the user.

The second token is information used for authentication in the settlement service. For example, the second token may be letters, numbers, symbols, or a combination thereof. The second token may include an encrypted (hashed) user ID, or may not specifically include an encrypted user ID. The validity period of the second token is the date and time when a period during which the second token is valid ends. For example, the validity period of the second token is a period for a predetermined time (for example, 60 days) after the second token is issued. No particular validity period may be set for the second token. The second token may be valid semi-permanently unless the user instructs updating. The second token may be updated before the validity period of the second token ends. The second token may be updated when some process in the settlement system 1 (for example, any step in FIG. 7 or FIG. 8) is executed. When the first token is updated, the second token may also be updated. In contrast, when the second token is updated, the first token may also be updated.

In the first embodiment, a case is exemplified in which the second token is issued on the condition that the wearable device 40 holds a valid first token. Further, a case is exemplified in which the second token is used for the wearable device 40 to communicate with the settlement server 20. For example, the second token may also be referred to as an access token for the wearable device 40 to access the settlement server 20. The second token may be used for purposes other than accessing the settlement server 20. For example, the second token may be used for authentication for accessing a computer (for example, a point server 60 in a modification example to be described below) other than the settlement server 20. The first token may not be particularly required to issue the second token. In this case, the first token may not be provided. An aspect in which the first token is not provided is also within the scope of the disclosure. For example, the second token may be issued when authentication is executed based on information for authentication stored in the wearable device 40 or the login account and password that are input to the wearable device 40 by the user.

In addition, the data stored in the data storage unit 100 is not limited to settlement database DB2. The data storage unit 100 may store data necessary for a settlement service. For example, the data storage unit 100 may store data of various screens displayed on a portable terminal application and a wearable device application. For example, the data storage unit 100 may store a program that indicates a process for verifying the second token. When the second token is not stored in the settlement server 20, the data storage unit 100 may store data other than the program necessary for verifying the second token. These programs and data may be similar to the programs and data adopted in known tokens.

### [Second Token Request Reception Unit]

The second token request reception unit 201 receives a second token request from a computer that transmits a second token request regarding the issuance of the second token. The second token request is data in a predetermined format for requesting the issuance of the second token. The second token request may be in any format and may be, for example, in a format according to the API specifications of the settlement server 20. The second token request may include any information. For example, the second token request may include the first token, the portable terminal ID of the portable terminal 30, the wearable device ID of the wearable device, a user ID, an encrypted user ID, other information with which the user ID can be searched for, a login account, other information with which the account can be searched for, or other information.

For example, the second token request reception unit 201 receives the second token request directly or indirectly from the computer that transmits the second token request. The meanings of “directly” and “indirectly” are as described above. In the first embodiment, a case where the wearable device 40 transmits the second token request is exemplified. For this reason, the second token request reception unit 201 receives the second token request directly or indirectly from the wearable device 40. For example, when the portable terminal 30 transfers the second token request from the wearable device 40 to the settlement server 20, the second token request reception unit 201 receives the second token request indirectly from the wearable device 40.

In addition, a computer other than the wearable device 40 may transmit the second token request. For example, the portable terminal 30 may transmit the second token request. In this case, the second token request reception unit 201 receives the second token request directly or indirectly from the portable terminal 30. In another example, the second token request reception unit 201 may receive the second token request from a computer other than the portable terminal 30 and the wearable device 40.

### [Second Token Issuance Unit]

The second token issuance unit 202 issues a second token. The second token issuance unit 202 issues the second token based on a predetermined token issuance method. The program and data necessary for issuing the second token are assumed to be stored in the data storage unit 200. The second token issuance unit 202 issues the second token based on the program and the data. The token issuance method may be a known method. For example, the token issuance method may be an issuance method adopted in OAuth2.0 or JWT. The token issuance method may be a method of generating random symbols, letters, numbers, or a combination thereof. Since the second token is issued differently from the first token, the token issuance method for the first token and the token issuance method for the second token may be different from each other.

For example, when the second token issuance unit 202 issues a second token for a certain user, the second token is stored in the settlement database DB2 in association with the user ID of the user. The user ID may be included in the second token request. In this case, the second token issuance unit 202 specifies the user ID from the second token request. Instead of the user ID, other information (for example, a temporarily valid ID) with which the user ID can be searched for may be included in the second token request. In this case, the second token issuance unit 202 specifies the user ID from the other information. A relationship between the other information and the user ID is defined in the settlement database DB2 or another database.

When a validity period is set for the second token, the second token issuance unit 202 determines the validity period of the second token. For example, the second token issuance unit 202 determines a point in time a predetermined time after the current time as the validity period of the second token. The second token issuance unit 202 stores the validity period in the ID database DB1 in association with the second token. For example, the second token issuance unit 202 may encrypt the user ID specified from the second token request and include the encrypted user ID in the second token. In this case, the second token issuance unit 202 may issue the encrypted user ID as the second token as it is, or may issue a second token including the encrypted user ID and other parts (for example, a part such as a random symbol, or a part in which basic information of the user is hashed). The encryption may be performed using a known encryption algorithm (for example, RSA encryption).

### [Second Token Transmission Unit]

The second token transmission unit 203 transmits the second token to the computer that transmits the second token request. For example, the second token transmission unit 203 transmits the second token directly or indirectly to the computer that transmits the second token request. The meanings of the terms “directly” and “indirectly” are as described above. In the first embodiment, the wearable device 40 transmits the second token request, and thus the second token transmission unit 203 transmits the second token to the wearable device 40. When a computer other than the wearable device 40 transmits the second token request, the second token transmission unit 203 may transmit the second token to the other computer.

When a validity period is set for the second token, the second token transmission unit 203 may transmit the second token and the validity period to the computer that transmits the second token request. The second token transmission unit 203 may not transmit the validity period to the computer that transmits the second token request. In this case, the validity period of the second token is managed by the settlement server 20. Whether the second token has a validity period is determined by the settlement server 20.

### [Code Display Request Reception Unit]

Functions of the settlement server 20 to be described below are functions related to verification of the second token and display of the code C420 on the wearable device 40. The display of the code C300 on the portable terminal 30 may be implemented by a known function.

The code display request reception unit 204 receives a code display request related to the display of a code used in a settlement service from the wearable device 40 that can be connected to the user's portable terminal 30 in the settlement service. The wearable device 40 that can be connected to the portable terminal 30 is the wearable device 40 that can wirelessly communicate with the portable terminal 30. The wireless communication may be performed in accordance with any communication standard such as Bluetooth (registered trademark) or infrared communication. The portable terminal 30 and the wearable device 40 are connected by pairing. A flow of the pairing may be a known flow. For example, the portable terminal 30 and the wearable device 40 authenticate each other by pairing.

For example, the code display request reception unit 204 receives a code display request directly or indirectly from the wearable device 40. The meanings of the terms “directly” and “indirectly” are as described above. In the first embodiment, when both the portable terminal application and the wearable device application are started up, the portable terminal 30 and the wearable device 40 are synchronized with each other. The code display request reception unit 204 receives a code display request from the wearable device 40 synchronized with the portable terminal 30. Since the wearable device 40 transmits the code display request after synchronizing with the portable terminal 30, the code display request reception unit 204 receives the code display request from the wearable device 40 after the wearable device 40 synchronizes with the portable terminal 30.

When the wearable device 40 stores a second token, the wearable device 40 may transmit the code display request without synchronizing with the portable terminal 30. That is, the wearable device 40 may transmit the code display request before synchronizing with the portable terminal 30. In this case, the wearable device 40 may determine whether the second token is stored in a data storage unit 400 to be described below, and when it is determined that the second token is stored, the wearable device 40 may transmit the code display request without synchronizing with the portable terminal 30.

In the first embodiment, the code display request includes the second token, and thus the code display request reception unit 204 receives the code display request including the second token from the wearable device 40. The code display request may not include the second token. For example, the second token may be data separate from the code display request. When the wearable device 40 can be identified with other information such as a session ID instead of the second token, the code display request reception unit 204 may receive a code display request including the other information from the wearable device 40.

In the first embodiment, the code display request reception unit 204 receives a code display request including a portable terminal ID and a wearable device ID from the wearable device 40. The portable terminal ID is an example of portable terminal identification information. For this reason, the portable terminal ID can be read as portable terminal identification information. The portable terminal identification information may be information other than the portable terminal ID. For example, the portable terminal identification information may be information such as a telephone number in a SIM card, individual identification information of the portable terminal 30, a MAC address of the portable terminal 30, identification information uniquely determined by a business operator operating a settlement service or the like, or other information.

The wearable device ID is an example of wearable device identification information. For this reason, the wearable device ID can be read as wearable device identification information. The wearable device identification information may be information other than the wearable device ID. For example, the wearable device identification information may be information such as a telephone number in a SIM card, individual identification information of the wearable device 40, a MAC address of the wearable device 40, identification information uniquely determined by a business operator operating a settlement service or the like, or other information.

The code display request may include any information. For example, the code display request may include a first token. The code display request may include a user ID, information (for example, a temporary ID) with which the user ID can be searched for, a login account, information (for example, a temporary ID) with which the login account can be searched for, or other information.

### [Second Token Verification Unit]

The second token verification unit 205 verifies a second token received from the wearable device 40. In this embodiment, the second token is included in a code display request, and thus the second token verification unit 205 verifies the second token included in the code display request. The verification of the second token is to confirm the validity of the second token. The second token verification unit 205 verifies the second token based on a predetermined token verification method. The token verification method may be a known method. For example, the token verification method may be a verification method adopted in OAuth2.0 or JWT.

For example, when the second token verification unit 205 verifies a second token of a certain user, the second token verification unit 205 determines whether the second token received by a second token reception unit 404 is stored in the settlement database DB2 in association with the user ID of the user. When the second token verification unit 205 determines that the second token is not stored in the settlement database DB2 in association with the user ID, the second token verification unit 205 determines that the second token is not valid. When the second token verification unit 205 determines that the second token is stored in the settlement database DB2 in association with the user ID, the second token verification unit 205 determines that the second token is valid.

The user ID may be included in the second token request. In this case, the second token verification unit 205 specifies the user ID from the second token. When the user ID is encrypted and included in the second token, the second token verification unit 205 decrypts the encrypted user ID included in the second token. The decryption may be performed by a known decryption algorithm (for example, RSA encryption). Instead of the user ID, other information with which the user ID can be searched for may be included in the second token. In this case, the second token verification unit 205 specifies the user ID from the other information. A relationship between the other information and the user ID is assumed to be defined in the settlement database DB2 or another database. The user ID or the other information may be data separate from the second token. In this case, the code display request reception unit 204 may receive the user ID or the other information together with the code display request including the second token.

Furthermore, when a validity period is set for the second token, the second token verification unit 205 may determine whether the second token within the validity period is received from the wearable device 40. The second token verification unit 205 may perform this determination based on the validity period stored in the settlement database DB2, or may perform this determination based on the validity period received together with the second token. The second token verification unit 205 determines that the second token is not valid when the second token is not within the validity period. The second token verification unit 205 may verify the second token by determining whether the second token is stored in the settlement database DB2, regardless of the user ID in particular.

### [Code Display Information Transmission Unit]

When a code display request is received, the code display information transmission unit 206 transmits code display information related to the display of the code C420 to the wearable device 40. The code display information is information used to display the code C420. In the first embodiment, a case where a code ID is equivalent to code display information is exemplified, but the code display information may include information (for example, URL) other than the code ID. The code display information may be image data of the code C420.

In the first embodiment, there are two codes C420: the barcode C420A and the two-dimensional code C420B. Code display information of the barcode C420A and code display information of the two-dimensional code C420B may be separate data or may be the same data. For example, the code display information transmission unit 206 may transmit each of the code display information of the barcode C420A and the code display information of the two-dimensional code C420B to the wearable device 40, or may transmit the code display information indicating the barcode C420A and the two-dimensional code C420B.

For example, the code display information transmission unit 206 issues a code ID based on a predetermined ID issuance rule. The ID issuance rule may be any rule. For example, the ID issuance rule may be a rule indicating that the code ID is to be issued as random letters, numbers, symbols, or a combination thereof. The code display information transmission unit 206 issues a code ID so that the issued code ID is not the same as other code IDs. When a validity period is determined for the code ID, the code display information transmission unit 206 issues the code ID so that the issued code ID is not the same as other code IDs within the validity period.

In this embodiment, the code display information is transmitted when the first token is verified, and thus the code display information transmission unit 206 transmits the code display information to the wearable device 40 when the first token is verified. The code display information transmission unit 206 transmits the code display information to the wearable device 40 on the condition that the first token is verified. Here, the first token being verified means that the validity of the first token is confirmed. When the first token is not used, the code display information transmission unit 206 may transmit the code display information to the wearable device 40 based on other conditions.

In this embodiment, the code display information transmission unit 206 transmits the code display information to the wearable device 40 when the second token included in the code display request is verified. The code display information transmission unit 206 transmits the code display information to the wearable device 40 on the condition that the second token is verified. Here, the second token being verified means that the validity of the second token is confirmed. When the second token is not used, the code display information transmission unit 206 may transmit the code display information to the wearable device 40 on the condition that the first token is verified.

### [Settlement Execution Unit]

When the code C420 is read, the settlement execution unit 207 executes a settlement. As described above, the settlement process may be the same as a known process. For example, the settlement execution unit 207 acquires a code ID, which is read from the code C420, from the store terminal 50. The settlement execution unit 207 determines whether the code ID acquired from the store terminal 50 is stored in the settlement database DB2. When it is determined that the code ID acquired from the store terminal 50 is stored in the settlement database DB2, the settlement execution unit 207 executes the settlement based on settlement means information associated with the code ID. The settlement execution unit 207 transmits the execution result of the settlement to the store terminal 50.

### [1-3-3. Function Implemented by Portable Terminal]

For example, the portable terminal 30 includes a data storage unit 300, a synchronization unit 301, a first token request transmission unit 302, a first token reception unit 303, a first token transmission unit 304, a transfer unit 305, and a display control unit 306. The data storage unit 300 is implemented by the storage unit 32. Each of the synchronization unit 301, the first token request transmission unit 302, the first token reception unit 303, the first token transmission unit 304, the transfer unit 305, and the display control unit 306 is implemented by the control unit 31.

### [Data Storage Unit]

The data storage unit 300 stores data necessary for a user to use a settlement service. For example, the data storage unit 300 stores a portable terminal application. When the user uses the settlement service from a browser rather than a portable terminal application, the data storage unit 300 stores the browser. The data storage unit 300 may store at least one of a first token and a second token. The data storage unit 300 stores the first token, but may not store the second token. In contrast, the data storage unit 300 stores the second token, but may not store the first token. The data storage unit 300 may store a portable terminal ID making it possible to identify the portable terminal 30. The data storage unit 300 may store a wearable device ID acquired from the wearable device 40. The data storage unit 300 may store a user ID, information with which the user ID can be searched for, the user's login account, information with which the login account can be searched for, or other information.

### [Synchronization Unit]

The synchronization unit 301 synchronizes the portable terminal 30 and the wearable device 40. In the first embodiment, the synchronization of the portable terminal 30 and the wearable device 40 is a process different from the pairing of the portable terminal 30 and the wearable device 40. The synchronization of the portable terminal 30 and the wearable device 40 is a process executed by a portable terminal application and a wearable device application after these applications are started up. In the synchronization of the portable terminal 30 and the wearable device 40, information necessary for the user to use the settlement service from the wearable device 40 is exchanged.

On the other hand, the pairing of the portable terminal 30 and the wearable device 40 is a process executed by another program, regardless of the portable terminal application and the wearable device application. For example, the other program may be an operating system or firmware. The pairing of the portable terminal 30 and the wearable device 40 is executed based on a procedure determined by a communication protocol of the wireless communication standard. The synchronization of the portable terminal 30 and the wearable device 40 is executed based on a procedure determined by the settlement service, not the communication protocol of the wireless communication standard.

For example, the synchronization unit 301 transmits the portable terminal ID to the wearable device 40. The synchronization unit 301 may transmit information (for example, information for authentication in the settlement service) other than the portable terminal ID to the wearable device 40. The other information may be stored in the data storage unit 300 or may be acquired from another computer (for example, the settlement server 20) by the portable terminal 30. When the other information is information for authentication in the settlement service, the settlement server 20 may be requested to confirm its validity. For example, when the first token is already stored in the data storage unit 300, the synchronization unit 301 may transmit the first token stored in the data storage unit 300 to the wearable device 40.

For example, the synchronization unit 301 receives the wearable device ID from the wearable device 40. The synchronization unit 301 may receive information (for example, information for authentication in the settlement service) other than the wearable device ID from the wearable device 40. The other information may be stored in the data storage unit 400 or may be acquired from another computer (for example, the settlement server 20) by the wearable device 40. When the other information is information for authentication in the settlement service, the settlement server 20 may be requested to confirm its validity. For example, when the second token is already stored in the data storage unit 400, the synchronization unit 301 may receive the second token stored in the data storage unit 400 from the wearable device 40.

### [First Token Request Transmission Unit]

The first token request transmission unit 302 transmits a first token request directly or indirectly to the computer that issues the first token. The meanings of the terms “directly” and “indirect” are as described above. In the first embodiment, the ID server 10 issues the first token, and thus the first token request transmission unit 302 transmits the first token request to the ID server 10. When a computer other than the ID server 10 issues the first token, the first token request transmission unit 302 only needs to transmit a first token request to the other computer. When the first token is already stored in the data storage unit 300, the first token request transmission unit 302 does not need to transmit a first token request.

### [First Token Reception Unit]

The first token reception unit 303 receives a first token from the computer that issues the first token. For example, the first token reception unit 303 receives the first token directly or indirectly from the computer that issues the first token. The meanings of the terms “directly” and “indirectly” are as described above. In the first embodiment, the ID server 10 issues the first token, and thus the first token reception unit 303 receives the first token from the ID server 10. That is, the first token reception unit 303 receives the first token from the first token transmission unit 304 of the ID server 10.

### [First Token Transmission Unit]

The first token transmission unit 304 transmits the first token to the wearable device 40. For example, the first token transmission unit 304 transmits the first token directly or indirectly to the wearable device 40. The meanings of the terms “directly” and “indirectly” are as described above. When the first token reception unit 303 receives the first token, the first token transmission unit 304 transmits the first token to the wearable device 40. When the first token is already stored in the data storage unit 300, the first token transmission unit 304 transmits the first token to the wearable device 40.

### [Transfer Unit]

The transfer unit 305 transfers any information to the wearable device 40. The transfer unit 305 transfers any information to a computer with which the wearable device 40 communicates. The transfer unit 305 allows the portable terminal 30 to function as a hub. The processing of the transfer unit 305 may be executed by a portable terminal application, or may be executed by a program other than the portable terminal application. The transfer unit 305 transfers the information to be transferred as it is without particularly processing the information. The transfer unit 305 transfers the information received from the wearable device 40 to the ID server 10, the settlement server 20, or another computer. For example, when the wearable device 40 can be connected to a public communication line, the wearable device 40 may transmit the information to be transmitted to the ID server 10, the settlement server 20, or another computer without going through the portable terminal 30. When the wearable device 40 cannot be connected to a public communication line but can be connected to a communication device such as a wireless LAN, the wearable device 40 may transmit the information to be transmitted to the ID server 10, the settlement server 20, or another computer without going through the portable terminal 30.

### [Display Control Unit]

The display control unit 306 displays various screens on the display unit 35. For example, the display control unit 306 displays each of the code screen SC30 and the completion screen SC31 on the display unit 35. The display control unit 306 communicates with the ID server 10, the settlement server 20, or another computer, receives data necessary for displaying these screens, and displays these screens on the display unit 35.

### [1-3-4. Function Implemented by Wearable Device]

For example, the wearable device 40 includes the data storage unit 400, a synchronization unit 401, a first token reception unit 402, a second token request transmission unit 403, the second token reception unit 404, a code display request transmission unit 405, a code display information reception unit 406, and a display control unit 407. The data storage unit 400 is implemented by the storage unit 42. Each of the synchronization unit 401, the first token reception unit 402, the second token request transmission unit 403, the second token reception unit 404, the code display request transmission unit 405, the code display information reception unit 406, and the display control unit 407 is implemented by the control unit 41.

### [Data Storage Unit]

The data storage unit 400 stores data necessary for a user to use a settlement service. For example, the data storage unit 400 stores a wearable device application. When the user uses the settlement service from a browser rather than the wearable device application, the data storage unit 400 stores the browser. The data storage unit 400 may also store a wearable device ID making it possible to identify the wearable device 40. When the wearable device 40 receives the portable terminal ID from the portable terminal 30, the data storage unit 400 may store the portable terminal ID. The data storage unit 400 may store the first token, the second token, the portable terminal ID, and the wearable device ID. The data storage unit 400 may store a user ID, information with which the user ID can be searched for, the user's login account, information with which the login account can be searched for, or other information.

### [Synchronization Unit]

The synchronization unit 401 synchronizes the portable terminal 30 and the wearable device 40. For example, the synchronization unit 401 transmits the wearable device ID to the portable terminal 30. The synchronization unit 401 may transmit information (for example, information for authentication in the settlement service) other than the wearable device ID to the portable terminal 30. The other information may be stored in the data storage unit 400 or may be acquired from another computer (for example, the settlement server 20) by the wearable device 40. When the other information is information for authentication in the settlement service, the settlement server 20 may be requested to confirm its validity.

For example, when the first token is already stored in the data storage unit 400, the synchronization unit 401 may transmit the first token stored in the data storage unit 400 to the portable terminal 30. When the second token is already stored in the data storage unit 400, the synchronization unit 401 may transmit the second token stored in the data storage unit 400 to the portable terminal 30.

For example, the synchronization unit 401 receives the portable terminal ID from the portable terminal 30. The synchronization unit 401 may receive information (for example, information for authentication in the settlement service) other than the portable terminal ID from the portable terminal 30. The other information may be stored in the data storage unit 400 or may be acquired from another computer (for example, the settlement server 20) by the wearable device 40. When the other information is information for authentication in the settlement service, the settlement server 20 may be requested to confirm its validity. For example, when the first token is already stored in the data storage unit 300, the synchronization unit 401 may receive the first token stored in the data storage unit 300 from the portable terminal 30.

### [First Token Reception Unit]

The first token reception unit 402 receives a first token from the computer that transmits the first token. In the first embodiment, the ID server 10 transmits the first token to the portable terminal 30, and the portable terminal 30 transmits the first token to the ID server 10. Thus, the first token reception unit 402 receives the first token indirectly from the ID server 10 via the portable terminal 30. That is, the first token reception unit 402 receives the first token transferred by the portable terminal 30 from which the ID server 10 received the first token.

In the first embodiment, the first token reception unit 402 receives the first token from the portable terminal 30 when synchronizing with the portable terminal 30. The first token reception unit 402 may receive the first token from a computer other than the portable terminal 30. For example, when the settlement server 20 transmits the first token, the first token reception unit 402 may receive the first token from the settlement server 20.

### [Second Token Request Transmission Unit]

The second token request transmission unit 403 transmits a second token request directly or indirectly to the computer that issues the second token. The meanings of the terms “directly” and “indirectly” are as described above. In the first embodiment, the settlement server 20 issues the second token, and thus the second token request transmission unit 403 transmits the second token request to the settlement server 20. When a computer other than the settlement server 20 issues the second token, the second token request transmission unit 403 only needs to transmit the second token request to the other computer. When the second token is already stored in the data storage unit 400, the second token request transmission unit 403 may not transmit the second token request.

### [Second Token Reception Unit]

The second token reception unit 404 receives a second token from the computer that issues the second token. For example, the second token reception unit 404 receives the second token directly or indirectly from the computer that issues the second token. The meanings of the terms “directly” and “indirectly” are as described above. In the first embodiment, the settlement server 20 issues the second token, and thus the second token reception unit 404 receives the second token from the settlement server 20. That is, the second token reception unit 404 receives the second token from the second token transmission unit 203 of the settlement server 20.

### [Code Display Request Transmission Unit]

The code display request transmission unit 405 transmits a code display request regarding the display of the code C420 used in the settlement service to the settlement server 20 of the settlement service. For example, the code display request transmission unit 405 transmits the code display request directly or indirectly to the settlement server 20. The meanings of the terms “directly” and “indirectly” are as described above. In the first embodiment, the settlement server 20 acquires code display information, and thus the code display request transmission unit 405 transmits the code display request to the settlement server 20. When a computer (for example, the ID server 10) other than the settlement server 20 acquires the code display information, the code display request transmission unit 405 may transmit the code display request to the other computer.

### [Code Display Information Reception Unit]

The code display information reception unit 406 receives code display information related to the display of a code from the settlement server 20. For example, the code display information reception unit 406 receives the code display information directly or indirectly from the settlement server 20. The meanings of the terms “directly” and “indirectly” are as described above. In the first embodiment, the code display information reception unit 406 receives the code display information from the code display information transmission unit 206 of the settlement server 20.

### [Display Control Unit]

The display control unit 407 displays the code C420 on the display unit 45 based on the code display information. For example, when the code ID is equivalent to the code display information, the display control unit 407 encodes the code ID and generates image data of the code C420. The display control unit 407 displays the code C420 on the display unit 45 based on the image data. When the image data of the code C420 is equivalent to the code display information, the display control unit 407 displays the code C420 on the display unit 45 based on the code display information which is image data.

[1-3-5. Function implemented by Store Terminal]

For example, the store terminal 50 includes a data storage unit 500 and a settlement execution unit 501. The data storage unit 500 is implemented by the storage unit 52. The settlement execution unit 501 is implemented by the control unit 51.

### [Data Storage Unit]

The data storage unit 300 stores data necessary for an affiliated store to use a settlement service. For example, the data storage unit 300 stores an application for the affiliated store.

### [Settlement Execution Unit]

The settlement execution unit 501 executes a settlement. As described above, the settlement process may be the same as a known process. For example, when the reading unit 56 reads the codes C300 and C420, the settlement execution unit 501 acquires code IDs from the codes C300 and C420. The settlement execution unit 501 transmits the code IDs to the settlement server 20. The settlement execution unit 501 acquires the execution result of the settlement from the settlement server 20. The settlement execution unit 501 displays a screen showing the execution result of the settlement on the display unit 55.

### 1-4. Process Executed by Settlement System According to First Embodiment

FIGS. 7 and 8 are diagrams showing an example of a process executed by the settlement system 1 according to the first embodiment. The processes shown in FIGS. 7 and 8 are executed by the control units 11, 21, 31, 41, and 51 executing programs (for example, a portable terminal application, a wearable device application, or other programs) stored in the storage units 12, 22, 32, 42, and 52, respectively. It is assumed that the pairing of the portable terminal 30 and the wearable device 40 (connection of terminals that are not synchronized) is already completed when the processes shown in FIGS. 7 and 8 are executed.

As shown in FIG. 7, when the user operates the operation unit 34 to select a portable terminal application, the portable terminal 30 starts up the portable terminal application (S100). In S100, the portable terminal 30 may execute a login process for the user to log in to the settlement service with respect to the settlement server 20. When the user operates the operation unit 44 to select a wearable device application, the wearable device 40 starts up the wearable device application (S101).

The wearable device 40 transmits a synchronization start request to start synchronization to the portable terminal 30 (S102). The synchronization start request is data in a predetermined format indicating a request to start synchronization. The synchronization start request may include a wearable device ID, information making it possible to identify a wearable device application, or a combination thereof. The portable terminal 30 receives the synchronization start request from the wearable device 40 (S103).

The portable terminal 30 determines whether a first token within the validity period is stored in the storage unit 32 (S104). When it is determined in S104 that a first token within the validity period is stored in the storage unit 32 (S104: Y), the process proceeds to S110 to be described below. When it is determined in S104 that a first token within the validity period is not stored in the storage unit 32 (S104: N), the portable terminal 30 transmits a first token request to the ID server 10 (S105).

The ID server 10 receives the first token request from the portable terminal 30 (S106). The ID server 10 issues a first token based on a predetermined token issuance method (S107). In S107, the ID server 10 determines the validity period of the first token. The ID server 10 specifies a user ID based on the first token request, and stores the first token and the validity period in the ID database DB1 in association with the user ID.

The ID server 10 transmits the first token and the validity period to the portable terminal 30 (S108). The portable terminal 30 receives the first token and the validity period from the ID server 10 (S109). In S109, the portable terminal 30 records the first token and the validity period in the storage unit 32. The portable terminal 30 transmits the first token to the wearable device 40 (S110). In S110, the portable terminal 30 may transmit the portable terminal ID together with the first token to the wearable device 40.

The wearable device 40 receives the first token and the validity period from the portable terminal 30 (S111). In S111, the wearable device 40 records the first token and the validity period in the storage unit 42. The wearable device 40 transmits a second token request including the first token to the settlement server 20 (S112).

The settlement server 20 receives the second token request from the wearable device 40 (S113). The settlement server 20 executes a first token verification process for verifying the first token included in the second token request with respect to the ID server 10 (S114). In S114, the settlement server 20 requests the ID server 10 to verify the first token. The ID server 10 verifies the first token based on the request from the settlement server 20. The settlement server 20 receives the verification result of the first token.

The settlement server 20 determines whether the first token is valid based on the processing result of S114 (S115). When it is determined in S115 that the first token is not valid (S115: N), an error occurs and this process ends. When it is determined in S115 that the first token is valid (S115: Y), the settlement server 20 issues a second token (S116). In S116, the settlement server 20 determines the validity period of the second token. The settlement server 20 specifies a user ID based on the second token request, and stores the second token and the validity period in the settlement database DB2 in association with the user ID.

The settlement server 20 transmits the second token and the validity period to the wearable device 40 (S117). At the time of the process of S117, the settlement server 20 may generate code display information and transmit it to the wearable device 40. The wearable device 40 receives the second token and the validity period from the settlement server 20 (S118). In S118, the wearable device 40 records the second token and the validity period in the storage unit 42. This completes the synchronization.

Thereafter, when the wearable device 40 communicates with the settlement server 20, the wearable device 40 transmits the second token to the settlement server 20. The wearable device 40 may determine whether a second token within the validity period is stored in the storage unit 42 at a point in time when the wearable device application is started up (at the time of S101). When it is determined that a second token within the validity period is stored in the storage unit 42, synchronization of the portable terminal 30 and the wearable device 40 may be omitted. In this case, the wearable device 40 may omit synchronization with the portable terminal 30 and execute the process of S119 and the subsequent processes. When it is determined that a second token within the validity period is not stored in the storage unit 42, the process of S103 may be executed.

Before the process of S119 to be described below is executed, the wearable device 40 may transmit the portable terminal ID and the wearable device ID to the settlement server 20. As in Modification Example 1-1 to be described below, a combination of the portable terminal ID and the wearable device ID may be stored in the settlement server 20. When the second token and the validity period are recorded in the storage unit 42 in S118, the process moves to FIG. 8, and the wearable device 40 transmits a code display request including the second token to the settlement server 20 (S119). The code display request also includes the wearable device ID.

The settlement server 20 receives the code display request from the wearable device 40 (S120). The settlement server 20 executes a second token verification process for verifying the second token included in the code display request (S121). The settlement server 20 determines whether the second token is valid based on the processing result of S121 (S122). When it is determined in S122 that the second token is not valid (S122: N), an error occurs and this process ends.

When it is determined in S122 that the second token is valid (S122: Y), the settlement server 20 issues a code ID as code display information (S123). In S123, the settlement server 20 stores the code ID in the settlement database DB2. As in a second embodiment to be described later, it may be determined whether a payment source can be used on the wearable device 40. Furthermore, when the payment source can be used on the wearable device 40, the process of S123 and the subsequent processes may be executed. When the payment source cannot be used on the wearable device 40, an error may occur.

The settlement server 20 transmits the code display information to the wearable device 40 (S124). The wearable device 40 receives the code display information from the settlement server 20 (S125). The wearable device 40 generates a code C420 based on the code ID received as the code display information, and displays the code screen SC42 on the display unit 45 (S126). In S126, when the user taps the code screen SC42, the barcode C420A and the two-dimensional code C420B are switched. When the store terminal 50 reads the code C420, it executes a settlement process with respect to the settlement server 20 (S127), and this process ends.

### 1-5. Summary of First Embodiment

The settlement system 1 according to the first embodiment receives a code display request from the wearable device 40. When the code display request is received, the settlement system 1 transmits code display information to the wearable device 40. Thereby, the wearable device 40 mainly transmits the code display request, thereby reducing a processing load of the portable terminal 30. For this reason, it is possible to prevent a failure in the display of the code C420 due to an increased processing load of the portable terminal 30, and thus user convenience can be improved. The user can use the settlement service smoothly by reliably displaying the code C420 on the wearable device 40. For example, the user can use the settlement service using only the wearable device 40 without carrying the portable terminal 30. As long as the wearable device 40 stores the second token, the wearable device 40 can communicate with the settlement server 20 and acquire the code display information even when the user does not have the portable terminal 30. For example, it is assumed that the user synchronizes the portable terminal 30 and the wearable device 40 at home and stores the second token in the wearable device 40. Thereafter, it is assumed that the user wears the wearable device 40 and visits an affiliated store while leaving the portable terminal 30 at home. When the wearable device 40 can transmit the second token to the settlement server 20 by using a public communication line, a wireless LAN in the affiliated store, or the like, the code C420 can be displayed on the wearable device 40 even when the user does not have the portable terminal 30. For this reason, user convenience can be improved. For example, when the portable terminal 30 mainly transmits the code display request, the user should carry both the portable terminal 30 and the wearable device 40. However, according to the settlement system 1 of the first embodiment, the user can use the settlement service from the wearable device 40 even when the user does not have the portable terminal 30.

Further, in the settlement system 1, when both the portable terminal application and the wearable device application are started up, the portable terminal 30 and the wearable device 40 are synchronized with each other. The settlement system 1 receives a code display request from the wearable device 40 synchronized with the portable terminal 30. Thereby, the settlement system 1 can set the synchronization between the portable terminal 30 and the wearable device 40 as a condition for the code display request, and thus security can be enhanced. For example, even when a third party acquires the wearable device 40 of the user, the third party cannot use the settlement service from the wearable device 40 unless the wearable device 40 is synchronized with the portable terminal 30 of the user, and thus the settlement system 1 can enhance security.

Further, in the settlement system 1, when the wearable device 40 is synchronized with the portable terminal 30, the wearable device 40 receives a first token from the portable terminal 30. The settlement system 1 receives the first token from the wearable device 40 synchronized with the portable terminal 30. The settlement system 1 verifies the first token received from the wearable device 40. When the first token is verified, the settlement system 1 transmits code display information to the wearable device 40. Thereby, the settlement system 1 can enhance security by not only synchronizing the portable terminal 30 and the wearable device 40, but also verifying the first token.

In addition, the settlement system 1 receives a code display request including a second token from the wearable device 40. The settlement system 1 verifies the second token included in the code display request. When the second token included in the code display request is verified, the settlement system 1 transmits code display information to the wearable device 40. Thereby, the settlement system 1 can enhance security by not only synchronizing the portable terminal 30 and the wearable device 40, but also verifying the second token.

Furthermore, in the settlement system 1, the wearable device 40 receives the portable terminal ID from the portable terminal 30. The settlement system 1 receives a code display request including the portable terminal ID and the wearable device ID from the wearable device 40. Thereby, the settlement system 1 can acquire the portable terminal ID and the wearable device ID to manage which pair of portable terminal 30 and wearable device 40 is used for the settlement service by the user. For example, when a fraud occurs in the settlement service, the settlement system 1 can specify the pair of portable terminal 30 and wearable device 40 in which the fraud occurred, making it easier to deal with the fraud after the occurrence of the fraud.

The wearable device 40 also transmits a code display request related to the display of the code C420 used in the settlement service to the settlement server 20. The wearable device 40 receives code display information related to the display of the code C420 from the settlement server 20. The wearable device 40 displays the code C420 on the display unit 45 based on the code display information. Thereby, the wearable device 40 mainly transmits the code display request, and thus a processing load of the portable terminal 30 is reduced. For this reason, it is possible to prevent a failure in the display of the code C420 due to an increased processing load of the portable terminal 30, and thus user convenience can be improved. For example, as described above, the user can use the settlement service from the wearable device 40 even when the user does not have the portable terminal 30.

### 2. Second Embodiment

Next, a second embodiment, which is an example of an embodiment of the settlement system 1, the wearable device 40, the processing execution method, and the program according to the disclosure, will be described. In the second embodiment, description of the same configuration as in the first embodiment will be omitted. For example, a hardware configuration of the settlement system 1 may be the same as that in the first embodiment.

### 2-1. Outline of Second Embodiment

In the second embodiment, a case is exemplified in which the wearable device 40 acquires a first token in the same manner as in the first embodiment. In addition, a case is exemplified in which the wearable device 40 acquires a second token based on the first token in the same manner as in the first embodiment. The wearable device 40 can access the settlement server 20 using the second token and acquire various information from the settlement server 20. The code display information described in the first embodiment is an example of information acquired using the second token.

In the second embodiment, a case is exemplified in which the wearable device 40 acquires setting information from the settlement server 20 based on the second token. Further, a case is exemplified in which the setting information indicates a payment source designated by the user on the portable terminal 30. As described in the first embodiment, the user can set any settlement means as a payment source. The wearable device 40 may cope with all settlement means or may cope with only some settlement means. When the wearable device 40 acquires the setting information from the settlement server 20, the wearable device 40 displays information on the payment source, which is designated by the user on the portable terminal 30, on the display unit 45. The wearable device 40 may not display the information on the payment source acquired from the settlement server 20 on the display unit 45, or may display only some of the information.

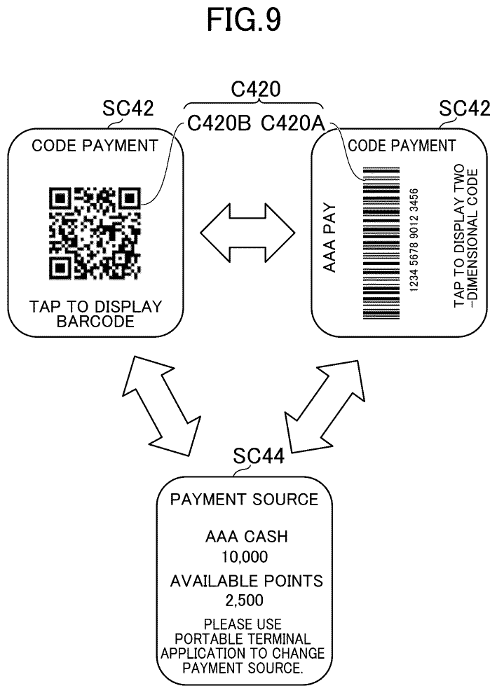

FIG. 9 is a diagram showing an example of a screen displayed on the wearable device 40. For example, when the wearable device 40 completes synchronization with the portable terminal 30, the wearable device 40 can switch between a state in which the barcode C420A is displayed and a state in which the two-dimensional code C420B is displayed, as shown in the upper part of FIG. 9. This point is as described in the first embodiment. For example, when the user performs an operation of displaying setting information from the operation unit 44 of the wearable device 40, the wearable device 40 displays a setting content screen SC44 showing the contents of the setting information on the display unit 45, as shown in the lower part of FIG. 9.

In an example in the lower part of FIG. 9, the setting content screen SC44 displays electronic money “AAA Cash” as the information on the payment source designated by the user. The user can switch between a state in which the code C420 is displayed and a state in which the information on the payment source is displayed by performing an operation such as swiping on the operation unit 44 of the wearable device 40. In the second embodiment, a case where the payment source is changed from the portable terminal 30 is exemplified, but the payment source may also be changed from the wearable device 40.

As described above, in the second embodiment, the wearable device 40 acquires setting information indicating the settings of the settlement service designated by the user from the settlement server 20. The wearable device 40 displays the setting content screen SC44, which indicates setting contents such as the payment source designated by the user from the portable terminal 30, on the display unit 45 based on the setting information. Thereby, the settlement system 1 is configured to improve user convenience. Details of the second embodiment will be described below.

### 2-2. Function Implemented by Settlement System According to Second Embodiment

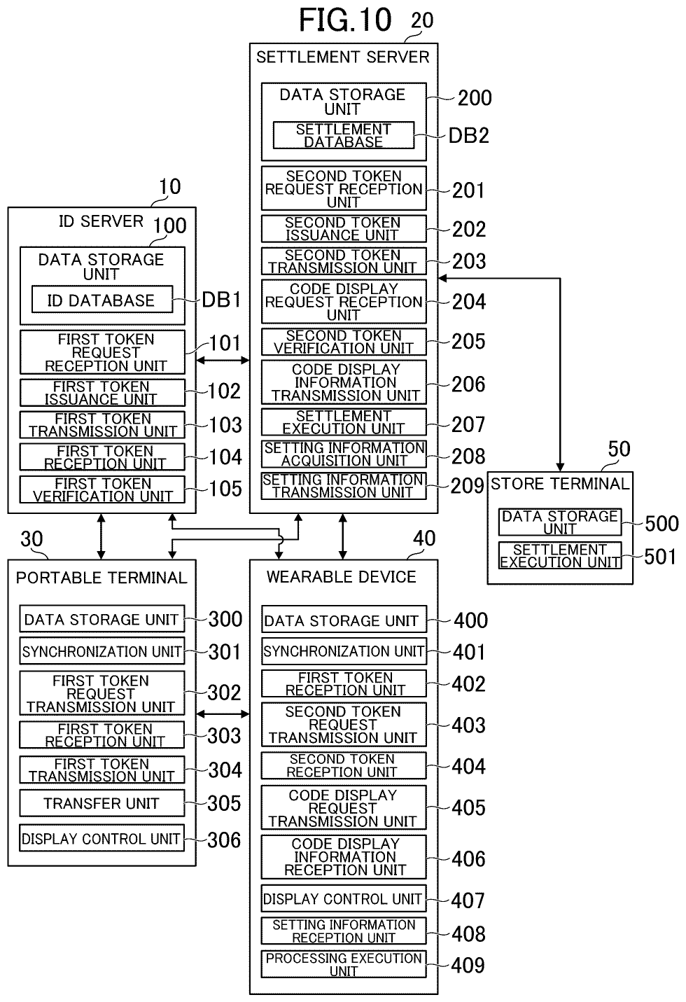

FIG. 10 is a diagram showing an example of a function implemented by the settlement system 1 according to the second embodiment. As in the first embodiment, parts implemented by the settlement system 1 can be configured by integrating them into one device or by distributing devices more finely.

In the second embodiment, the settlement system 1 may not include at least some of the functions described in the first embodiment. For example, the settlement system 1 may not include a configuration in which the wearable device 40 transmits a code display request. In this case, the code display request may be transmitted mainly by the portable terminal 30. As another example, in the second embodiment, instead of a settlement method of a type in which a code is displayed on the wearable device 40, a settlement method in which a settlement is executed by using a communication function of the wearable device 40 may be used.

When the first and second embodiments are combined, the settlement system 1 may be configured such that the wearable device 40 transmits a code display request. It is a matter in the settlement system 1 that a person skilled in the art can naturally understand from the description of the disclosure that both a mode in which the wearable device 40 transmits a code display request and a mode in which the portable terminal 30 transmits a code display request are described in the disclosure. Hereinafter, a case will be exemplified in which the settlement system 1 has the same functions as in the first embodiment and also has the functions described in the second embodiment.

### [2-2-1. Function Implemented by ID Server]

For example, the function of the ID server 10 may be the same as that in the first embodiment.

### [2-2-2. Function Implemented by Settlement Server]

For example, the settlement server 20 includes a setting information acquisition unit 208 and a setting information transmission unit 209. The setting information acquisition unit 208 and the setting information transmission unit 209 are each implemented by the control unit 21. Other functions shown in FIG. 10 may be the same as those in the first embodiment. For example, the code display request reception unit 204 may be the same as that in the first embodiment. The code display request reception unit 204 may receive a code display request which is related to the display of a code used in a settlement service and includes a user ID. The code display request reception unit 204 may receive the code display request from the wearable device 40. The code display request reception unit 204 may receive a code display request from the portable terminal 30. For example, the second token included in the code display request includes an encrypted user ID, and thus the code display request may include the encrypted user ID.

### [Setting Information Acquisition Unit]

The setting information acquisition unit 208 acquires setting information related to settings related to a settlement service, the settings being designated by the portable terminal 30 of the user in the settlement service. In the second embodiment, since the setting information is stored in the settlement database DB2, the setting information acquisition unit 208 acquires the setting information from the settlement database DB2. When the setting information is stored in a database other than the settlement database DB2, the setting information acquisition unit 208 may acquire the setting information from the other database. When the setting information is recorded in a computer or information storage medium other than the settlement server 20, the setting information acquisition unit 208 may acquire the setting information from the other computer or information storage medium.

For example, the setting information acquisition unit 208 specifies the user ID of the user for which the setting information is to be acquired, based on information acquired from the wearable device 40. This information may be the user ID itself or may be other information (for example, a temporary ID) with which the user ID can be searched for. The setting information acquisition unit 208 acquires setting information associated with the user ID. For example, the setting information acquisition unit 208 may acquire the setting information based on the user ID included in the second token. When the code display request includes the second token as in the first embodiment, the setting information acquisition unit 208 may acquire the setting information based on the user ID included in the second token.

### [Setting Information Transmission Unit]

The setting information transmission unit 209 transmits the setting information to the wearable device 40 that can be connected to the portable terminal 30. For example, the setting information transmission unit 209 transmits the setting information directly or indirectly to the wearable device 40. The meanings of “directly” and “indirectly” are as described in the first embodiment. For example, the setting information transmission unit 209 may transmit only the setting information to the wearable device 40 or may transmit other information together with the setting information.

In the second embodiment, the setting information transmission unit 209 transmits the setting information and code display information related to the display of a code to the wearable device 40. That is, the setting information transmission unit 209 transmits the setting information together with the code display information to the wearable device 40. The setting information may be included in the code display information. In contrast, the code display information may be included in the setting information. A method of transmitting the code display information may be the same as in the first embodiment. The setting information transmission unit 209 may include the code display information transmission unit 206 described in the first embodiment. The setting information transmission unit 209 may transmit the setting information and the code display information separately to the wearable device 40.

### [2-2-3. Function Implemented by Portable Terminal]

The function implemented by the portable terminal 30 may be the same as that in the first embodiment.

### [2-2-4. Function Implemented by Wearable Device]

For example, the wearable device 40 includes a setting information reception unit 408 and a processing execution unit 409. The setting information reception unit 408 and the processing execution unit 409 are implemented by the control unit 41. The other functions shown in FIG. 10 may be the same as those in the first embodiment. In the second embodiment, a case where the code display request transmission unit 405 is equivalent to a request transmission unit is exemplified. The request transmission unit transmits a predetermined request to the settlement server 20. The predetermined request may be a code display request or a setting information request for acquiring setting information. That is, the setting information may not be acquired in response to the code display request, but may be acquired in response to the setting information request. The setting information request may be included in the code display request.

For example, the wearable device 40 may transmit a setting information request for acquiring setting information to the settlement server 20, in addition to the code display request. In this case, the request transmission unit has a different function from the code display request transmission unit 405. The setting information request is data in a predetermined format for requesting setting information. The setting information request may be in any format and may be, for example, in a format according to the API specifications of the settlement server 20. The setting information request may include any information. For example, the setting information request may include the first token, the second token, the portable terminal ID of the portable terminal 30, the wearable device ID of the wearable device, the user ID, the encrypted user ID, other information with which the user ID can be searched for, a login account, other information with which the account can be searched for, or other information.

### [Setting Information Reception Unit]

The setting information reception unit 408 receives setting information related to the settings from the settlement server. The setting information reception unit 408 receives the setting information from a computer that acquires the setting information. For example, the setting information reception unit 408 receives the setting information directly or indirectly from a computer that manages the setting information. The meanings of the terms “directly” and “indirectly” are as described above. In the second embodiment, as in the first embodiment, the settlement server 20 manages the setting information, and thus the setting information reception unit 408 receives the setting information from the settlement server 20. That is, the setting information reception unit 408 receives the setting information from the setting information transmission unit 209 of the settlement server 20. In the second embodiment, the data storage unit 400 may store the setting information received by the setting information reception unit 408.

### [Processing Execution Unit]

The processing execution unit 409 executes a process related to the settlement service based on the setting information. The process related to the settlement service is a process executed based on the setting information. For example, the processing execution unit 409 executes a process of displaying the settings indicated by the setting information on the display unit 45 as a process related to the settlement service. The processing execution unit 409 may execute a process of coding the setting information into the code C420 as a process related to the settlement service. The processing execution unit 409 may execute a process of transmitting the setting information to the store terminal 50 by wireless communication as a process related to the settlement service. The processing execution unit 409 may execute a process of transmitting a settlement request to the settlement server 20 based on the setting information as a process related to the settlement service.

### [2-2-5. Function Implemented by Store Terminal]

The function implemented by the store terminal 50 may be the same as that in the first embodiment.

### 2-3. Process Executed by Settlement System According to Second Embodiment

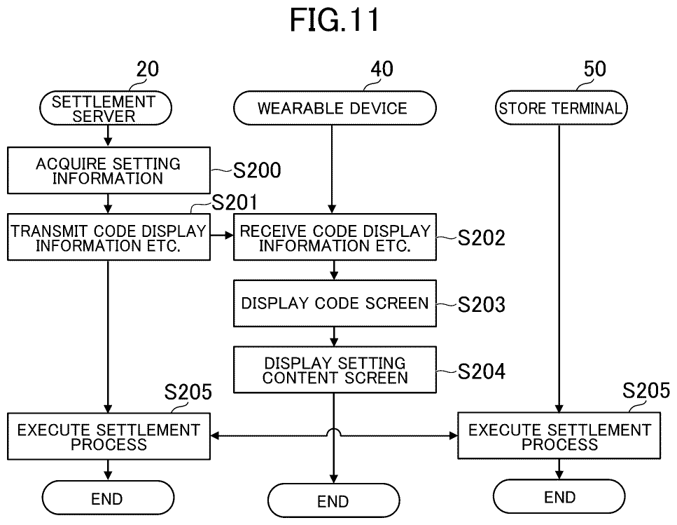

FIG. 11 is a diagram an example of a process executed by the settlement system 1 according to the second embodiment. The processes shown in FIG. 11 are executed by the control units 11, 21, 31, 41, and 51 executing programs (for example, a portable terminal application, a wearable device application, or other programs) stored in the storage units 12, 22, 32, 42, and 52, respectively. It is assumed that the pairing of the portable terminal 30 and the wearable device 40 is already completed when the processes in FIG. 11 are executed.

In the second embodiment, the same processes as S100 to S123 are executed. FIG. 11 shows the subsequent processes. The settlement server 20 acquires setting information based on a user ID included in a code display request (S200). The settlement server 20 transmits the setting information and code display information to the wearable device 40 (S201). The wearable device 40 receives the setting information and the code display information from the settlement server 20 (S202). The wearable device 40 generates a code C420 based on a code ID received as the code display information, and displays the code screen SC42 on the display unit 45 (S203).

The wearable device 40 displays the settings indicated by the setting information on the setting content screen SC44 based on the user's operation (S204). As described with reference to FIG. 9, the wearable device 40 switches between a state in which the code screen SC42 is displayed and a state in which the setting content screen SC44 is displayed based on the user's operation. The code C420 is read by the store terminal 50 in a state where the code screen SC42 is displayed. When the store terminal 50 reads the code C420, the store terminal 50 executes a settlement process with respect to the settlement server 20 (S205), and this process ends.

### 2-4. Summary of Second Embodiment

The settlement system 1 according to the second embodiment acquires setting information regarding the settings related to the settlement service. The settlement system 1 transmits the setting information to the wearable device 40 that can be connected to the portable terminal 30. Thereby, since the wearable device 40 can acquire the setting information, the settlement system 1 can improve user convenience. For example, when the wearable device 40 displays the settings indicated by the setting information, the user can confirm the settings on the wearable device 40, and thus the settlement system 1 can improve user convenience. For example, since the user does not need to make settings on the wearable device 40, the settlement system 1 can improve user convenience. For example, since the wearable device 40 does not need to have a function of setting a payment source, the development cost of the wearable device application can be reduced.

The settlement system 1 also receives a code display request including a user ID. The settlement system 1 acquires setting information based on the user ID included in the code display request. Thereby, when the settlement system 1 receives the code display request, the settlement system 1 can acquire the setting information in accordance with a series of flows as it is and transmit the setting information to the wearable device 40, and thus user convenience can be improved.

The settlement system 1 also transmits the setting information and code display information related to the display of a code to the wearable device 40. Thereby, the settlement system 1 can acquire the setting information in accordance with a series of flows for acquiring the code display information and transmit the setting information to the wearable device 40, and thus user convenience can be improved.

The wearable device 40 also transmits a predetermined request to the settlement server 20. The wearable device 40 receives the setting information from the settlement server 20. The settlement system s 1 executes a process related to the settlement service based on the setting information. Thereby, the wearable device 40 can execute a flexible process according to the setting information, and thus user convenience can be improved. For example, when the wearable device 40 displays the settings indicated by the setting information, the user can confirm the settings on the wearable device 40, and thus the settlement system 1 can improve user convenience.

### 3. Modification Example

The disclosure is not limited to the above-described embodiments. The disclosure can be modified as appropriate without departing from the spirit of the disclosure.

### 3-1. Modification Example of First Embodiment

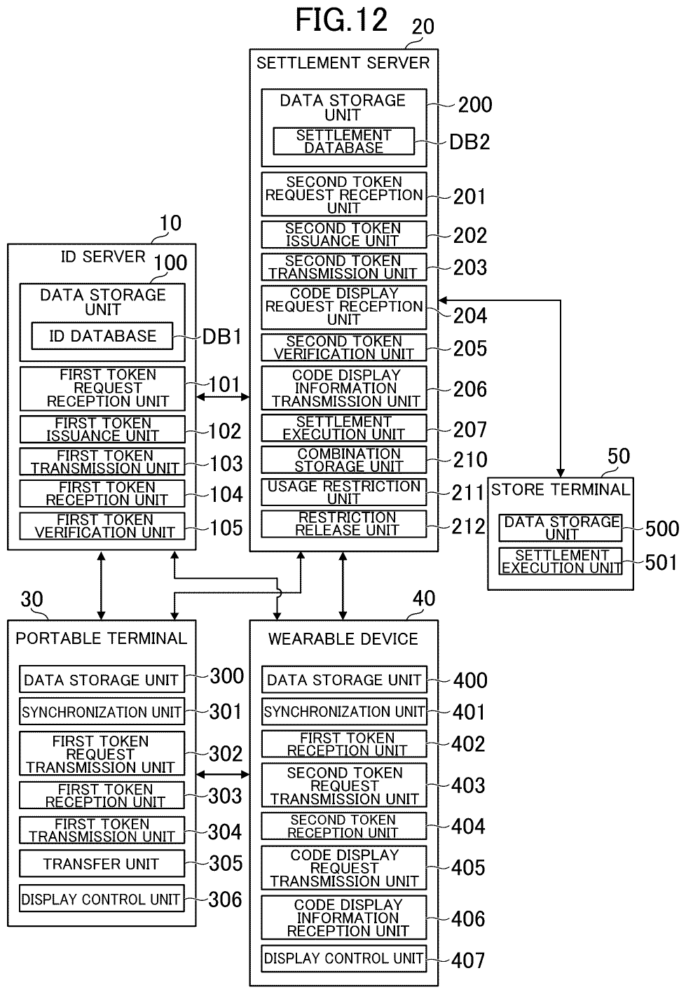

FIG. 12 is a diagram showing an example of functions implemented in Modification Examples 1-1 to 1-3. For example, the settlement server 20 includes a combination storage unit 210, a usage restriction unit 211, and a restriction release unit 212. Each of the combination storage unit 210, the usage restriction unit 211, and the restriction release unit 212 is implemented by the control unit 21.

### Modification Example 1-1

For example, in the first embodiment, a case is exemplified in which the settlement server 20 acquires the portable terminal ID and the wearable device ID from the wearable device 40. When a fraud occurs in the settlement service, when there is a concern of a fraud occurring in the settlement service, or when a report (for example, a report of loss of the portable terminal 30 or the wearable device 40) is made by the user, the settlement server 20 may prevent a future fraud by restricting the usage of at least one of the portable terminal 30 and the wearable device 40 based on a combination of the portable terminal ID and the wearable device ID.

The settlement system 1 according to Modification Example 1-1 includes the combination storage unit 210 and the usage restriction unit 211. The combination storage unit 210 stores a combination of the portable terminal ID and the wearable device ID received from the wearable device 40. In Modification Example 1-1, a case is exemplified in which the combination storage unit 210 stores a combination of the portable terminal ID and the wearable device ID in the settlement database DB2. The combination storage unit 210 may store a combination of the portable terminal ID and the wearable device ID in a database (for example, a database dedicated to the above combination) other than the settlement database DB2, in a computer other than the settlement server 20, or in an external information storage medium.

For example, the wearable device 40 can transmit the portable terminal ID and the wearable device ID to the settlement server 20 at any timing. In Modification Example 1-1, a case is exemplified in which the wearable device 40 transmits the portable terminal ID and the wearable device ID to the settlement server 20 after a second token is issued and before a code display request is transmitted. The wearable device 40 may transmit the second token to the settlement server 20 together with the portable terminal ID and the wearable device ID.

In addition, the wearable device 40 may transmit the portable terminal ID and the wearable device ID to the settlement server 20 at other timing. For example, the wearable device 40 may transmit the portable terminal ID and the wearable device ID when transmitting a second token request. That is, the wearable device 40 may transmit the second token request including the portable terminal ID and the wearable device ID to the settlement server 20. As another example, when a first token is issued, the portable terminal 30 may transmit its own portable terminal ID and the wearable device ID received from the wearable device 40 to the settlement server 20.

For example, the wearable device 40 may transmit the portable terminal ID and the wearable device ID when transmitting a code display request. That is, the wearable device 40 may transmit the code display request including the portable terminal ID and the wearable device ID to the settlement server 20. The settlement server 20 may receive the portable terminal ID and the wearable device ID from the wearable device 40 separately, rather than receiving the portable terminal ID and the wearable device ID all at once.

For example, when the settlement server 20 receives a portable terminal ID and a wearable device ID from the wearable device 40 of a certain user, the combination storage unit 210 stores a combination of the portable terminal ID and the wearable device ID in the settlement database DB2 in association with a user ID of the user. The settlement server 20 may receive the user ID together with the portable terminal ID and the wearable device ID from the wearable device 40, or may receive other information (for example, a temporary ID) with which the user ID can be searched for. A method in which the settlement server 20 specifies the user ID may be a known method.

The usage restriction unit 211 restricts the usage of at least one of the portable terminal 30 and the wearable device 40 based on a combination of the portable terminal ID and the wearable device ID. Restricting the usage of the portable terminal 30 means that the settlement service cannot be used from the portable terminal 30. For example, not displaying the code C300 on the portable terminal 30, not executing a settlement even when the code C300 displayed on the portable terminal 30 is read, or not executing a settlement even when a request for execution of a settlement is received from the portable terminal 30 is equivalent to restricting the usage of the portable terminal 30. The usage restriction unit 211 may associate a usage restriction flag, which indicates whether the portable terminal 30 is to be subjected to usage restriction, with the portable terminal ID of the portable terminal 30 subjected to usage restriction in the settlement database DB2. The usage restriction unit 211 may restrict the usage of the portable terminal 30 based on the usage restriction flag.

Restricting the usage of the wearable device 40 means making it impossible to use the settlement service from the wearable device 40. For example, not displaying the code C420 on the wearable device 40, not executing a settlement even when the code C420 displayed on the wearable device 40 is read, or not executing a settlement even when a request for execution of a settlement is received from the wearable device 40 is equivalent to restricting the usage of the wearable device 40. In the settlement database DB2, the usage restriction unit 211 may associate a usage restriction flag, which indicates whether the wearable device 40 is to be subjected to usage restriction, with the wearable device ID of the wearable device 40 that is subjected to usage restriction. The usage restriction unit 211 may restrict the usage of the wearable device 40 based on the usage restriction flag.

For example, the usage restriction unit 211 restricts the usage of at least one of the portable terminal 30 and the wearable device 40 based on usage restriction data indicating usage restriction according to a combination of the portable terminal ID and the wearable device ID. The usage restriction data is assumed to be stored in the data storage unit 200. The usage restriction data may be in any format. For example, the usage restriction data may be data in a table format, in a mathematical formula format, a part of a program, a machine learning model, or in other formats. The usage restriction unit 211 determines whether to restrict the usage of the portable terminal 30 of a certain user, restrict the usage of the wearable device 40 of the user, or restrict both of them based on the usage restriction data.

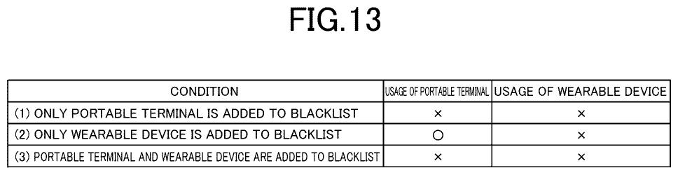

FIG. 13 is a diagram showing an example of usage restriction data. In the example shown in FIG. 13, the usage restriction data shows usage restrictions according to a blacklist. The blacklist is a list showing at least one of a portable terminal ID and a wearable device ID that are subjected to usage restrictions. In Modification Example 1-1, a case where a blacklist is stored in the data storage unit 200 is exemplified. The blacklist may be stored in a computer other than the settlement server 20, or in an external information storage medium.

A method of adding at least one of the portable terminal ID and the wearable device ID to the blacklist may be a known method. For example, the settlement server 20 may receive a blacklist created by an administrator who manages the settlement service from the administrator's administrator terminal and record the blacklist in the data storage unit 200. The settlement server 20 may receive, from the administrator terminal, at least one of the portable terminal ID and the wearable device ID designated by the administrator without receiving the blacklist itself, and may add the at least one of them to the blacklist stored in the data storage unit 200.

In addition, at least one of the portable terminal ID and the wearable device ID to be added to the blacklist may be automatically specified on the settlement service side, rather than being designated by the administrator. For example, the settlement server 20 may determine whether a fraud detection condition for fraud detection is satisfied based on the usage status of the settlement service (for example, a settlement location, a settlement amount, or the date and time of settlement), and may add at least one of the portable terminal ID and the wearable device ID to the blacklist based on the execution result of the determination. The fraud detection may be performed by a machine learning model. For fraud detection in the settlement service, a known method may be used.

For example, the usage restriction unit 211 specifies at least one of a portable terminal ID and a wearable device ID that are subjected to usage restriction based on the usage restriction data and the blacklist, and restricts the usage of at least one of them. That is, the usage restriction unit 211 specifies a combination of the portable terminal ID and the wearable device ID stored in the settlement database DB2, determines whether at least one of the specified portable terminal ID and wearable device ID is added to the blacklist, and determines whether to restrict the usage of at least one of the specified portable terminal ID and wearable device ID based on the execution result of the determination and the usage restriction data.

For example, when a certain portable terminal ID is added to the blacklist and a wearable device ID associated with the portable terminal ID is not added to the blacklist (in the case of a pattern (1) in FIG. 13), the usage restriction unit 211 restricts the usage of both the portable terminal 30 indicated by the portable terminal ID and the wearable device 40 indicated by the wearable device ID. In this case, the usage restriction unit 211 executes the above-described usage restriction process on both the portable terminal 30 and the wearable device 40 of which a combination is stored in the settlement database DB2. The wearable device ID associated with the certain portable terminal ID is the wearable device ID that forms a set together with the portable terminal ID.

For example, when a certain portable terminal ID is not added to the blacklist and a wearable device ID associated with the portable terminal ID is added to the blacklist (in the case of a pattern (2) in FIG. 13), the usage restriction unit 211 does not restrict the usage of the portable terminal 30 indicated by the portable terminal ID, but restricts the usage of the wearable device 40 indicated by the wearable device ID. In this case, the usage restriction unit 211 does not execute the above-described usage restriction process for the portable terminal 30 among the portable terminals 30 and the wearable devices 40 of which combinations are stored in the settlement database DB2, but executes the above-described usage restriction process for the wearable device 40.

For example, when a certain portable terminal ID is added to the blacklist and a wearable device ID associated with the portable terminal ID is also added to the blacklist (in the case of a pattern (3) in FIG. 13), the usage restriction unit 211 restricts the usage of both the portable terminal 30 indicated by the portable terminal ID and the wearable device 40 indicated by the wearable device ID. In this case, the usage restriction unit 211 executes the above-described usage restriction process for both the portable terminal 30 and the wearable device 40 of which a combination is stored in the settlement database DB2.

The usage restriction process performed by the usage restriction unit 211 is not limited to the above-described example. The usage restriction unit 211 may perform usage restriction according to a combination of a portable terminal ID and a wearable device ID. For example, the usage restriction unit 211 may perform usage restriction without particularly using a blacklist and usage restriction data. The usage restriction unit 211 may restrict the usage of the wearable device 40 indicated by a wearable device ID associated with a certain portable terminal ID, based on a usage restriction flag associated with the portable terminal ID of the portable terminal 30. In contrast, the usage restriction unit 211 may restrict the usage of the portable terminal 30 indicated by a portable terminal ID associated with a certain wearable device ID, based on a usage restriction flag associated with the wearable device ID of the wearable device 40.

The settlement system 1 according to Modification Example 1-1 stores a combination of a portable terminal ID and a wearable device ID received from the wearable device 40. The settlement system 1 restricts the usage of at least one of the portable terminal 30 and the wearable device 40 based on the combination. Thereby, the settlement system 1 can increase the security of a settlement service. For example, according to the usage restriction data as shown in FIG. 13, the settlement system 1 can impose usage restrictions according to each pattern shown in the usage restriction data, thereby increasing flexibility in the settlement service.

### Modification Example 1-2

For example, in Modification Example 1-1, the restriction on the usage of at least one of the portable terminal 30 and the wearable device 40 may be released under predetermined conditions. Releasing the restriction means that at least one of them that were subjected to the restriction can be used again in the settlement service. That is, releasing the restriction means returning the state to the state before the usage was restricted. In Modification Example 1-2, a case is exemplified in which the restriction is released in accordance with a combination of the portable terminal 30 and the wearable device 40. For example, deletion from the blacklist or a change in the value of the usage restriction flag is equivalent to the release of the restriction.

The settlement system 1 according to Modification Example 1-2 includes the restriction release unit 212. After the usage of at least one of the portable terminal 30 and the wearable device 40 is restricted, the restriction release unit 212 releases the restriction on at least one of the portable terminal 30 and the wearable device 40 based on a combination of the portable terminal 30 and the wearable device 40. In Modification Example 1-2, a case is exemplified in which a blacklist is stored in the data storage unit 200 as in Modification Example 1-1.

For example, an administrator for a settlement service deletes at least one of a portable terminal ID and a wearable device ID from the blacklist. Instead of the administrator manually deleting them from the blacklist, the deletion from the blacklist may be performed automatically by program processing. For example, when a predetermined period of time elapses since at least one of the portable terminal ID and the wearable device ID is added to the blacklist, the at least one of the portable terminal ID and the wearable device ID may be automatically deleted from the blacklist. The deletion from the blacklist may be performed by a machine learning model. The deletion from the blacklist may be performed using a known method.

For example, the restriction release unit 212 releases the restriction on at least one of the portable terminal 30 and the wearable device 40 based on restriction release data indicating the release of the restriction according to a combination of the portable terminal ID and the wearable device ID. The restriction release data is assumed to be stored in the data storage unit 200. The restriction release data may be in any format. For example, the restriction release data may be data in a table format, in a mathematical formula format, a part of a program, a machine learning model, or in other formats. The restriction release unit 212 determines whether to release the restriction on the portable terminal 30, the restriction on the wearable device 40, or both of them based on the restriction release data.

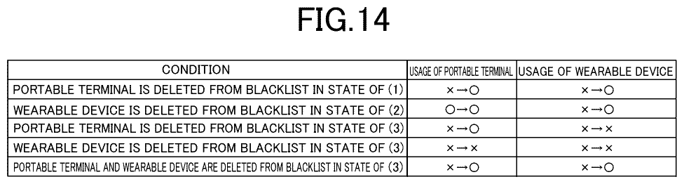

FIG. 14 is a diagram showing an example of restriction release data. In the example shown in FIG. 14, the restriction release data indicates the release of restriction according to deletion from a blacklist. For example, the restriction release unit 212 specifies at least one of a portable terminal ID and a wearable device ID for which usage restrictions are to be released, based on the restriction release data and the blacklist, and releases the usage restriction on at least one of them.

For example, in a state where a certain portable terminal ID is added to the blacklist, and a wearable device ID associated with the portable terminal ID is not added to the blacklist (in the state of the pattern (1) in FIG. 13), when the portable terminal ID is deleted from the blacklist, the restriction release unit 212 releases the usage restrictions on both the portable terminal 30 indicated by that portable terminal ID and the wearable device 40 indicated by that wearable device ID. In this case, the restriction release unit 212 executes the above-described restriction release process for both the portable terminal 30 and the wearable device 40 of which a combination is stored in the settlement database DB2.

For example, in a state where a certain portable terminal ID is not added to the blacklist, and a wearable device ID associated with the portable terminal ID is added to the blacklist (in the state of the pattern (2) in FIG. 13), when the wearable device ID is deleted from the blacklist, the restriction release unit 212 releases the usage restriction on the wearable device 40 indicated by the wearable device ID. In this case, the usage of the portable terminal 30 indicated by the portable terminal ID is not restricted initially, and thus a restriction release process is not executed for the portable terminal 30. The usage restriction unit 211 executes the above-described restriction release process for the wearable device 40 among the portable terminals 30 and the wearable devices 40 of which combinations are stored in the settlement database DB2.

For example, in a state where a certain portable terminal ID is added to the blacklist, and a wearable device ID associated with the portable terminal ID is also added to the blacklist (in the state of the pattern (3) in FIG. 13), when the portable terminal ID is deleted from the blacklist, the restriction release unit 212 releases the usage restriction on the portable terminal 30 indicated by the portable terminal ID. In this case, the usage restriction unit 211 executes the above-described restriction release process for the portable terminal 30 among the portable terminals 30 and the wearable devices 40 of which combinations are stored in the settlement database DB2. The usage restriction on the wearable device 40 is not released.

For example, in a state where a certain portable terminal ID is added to the blacklist, and a wearable device ID associated with the portable terminal ID is also added to the blacklist (in the state of the pattern (3) in FIG. 13), when the wearable device ID is deleted from the blacklist, the restriction release unit 212 does not release the usage restriction. In this case, the usage of each of the portable terminal 30 indicated by the portable terminal ID and the wearable device 40 indicated by the wearable device ID is continuously restricted.

For example, in a state where a certain portable terminal ID is added to the blacklist, and the wearable device ID associated with the portable terminal ID is also added to the blacklist (in the state of the pattern (3) in FIG. 13), when both the portable terminal ID and the wearable device ID are deleted from the blacklist, the restriction release unit 212 releases both the usage restriction on the portable terminal 30 indicated by the portable terminal ID and the usage restriction on the wearable device 40 indicated by the wearable device ID.

The restriction release process performed by the restriction release unit 212 is not limited to the above-described example. The restriction release unit 212 may perform restriction release according to a combination of the portable terminal ID and the wearable device ID. For example, the restriction release unit 212 may perform restriction release without particularly using a blacklist and restriction release data. The restriction release unit 212 may release the restriction on the wearable device 40 indicated by a wearable device ID associated with the portable terminal ID of a certain portable terminal 30 based on a usage restriction flag associated with the portable terminal ID. In contrast, the restriction release unit 212 may release the restriction on the portable terminal 30 indicated by a portable terminal ID associated with a wearable device ID of a certain wearable device 40 based on a usage restriction flag associated with the wearable device ID.

The settlement system 1 according to Modification Example 1-2 releases the restriction on at least one of the portable terminal 30 and the wearable device 40 based on a combination of the portable terminal 30 and the wearable device 40, after the usage of at least one of the portable terminal 30 and the wearable device 40 is restricted. Thereby, the settlement system 1 can prevent a decrease in user convenience while increasing the security of a settlement service. For example, according to the restriction release data as shown in FIG. 14, the settlement system 1 can perform restriction release according to each pattern shown in the restriction release data, thereby increasing the flexibility of the settlement service.

### Modification Example 1-3

For example, in the first embodiment, a case where the wearable device 40 displays the code C420 for payment is exemplified, but the wearable device 40 may display a code as a point card. In Modification Example 1-3, the code C420 for payment described in the first embodiment is referred to as a first code C420. A code as a point card is referred to as a second code.

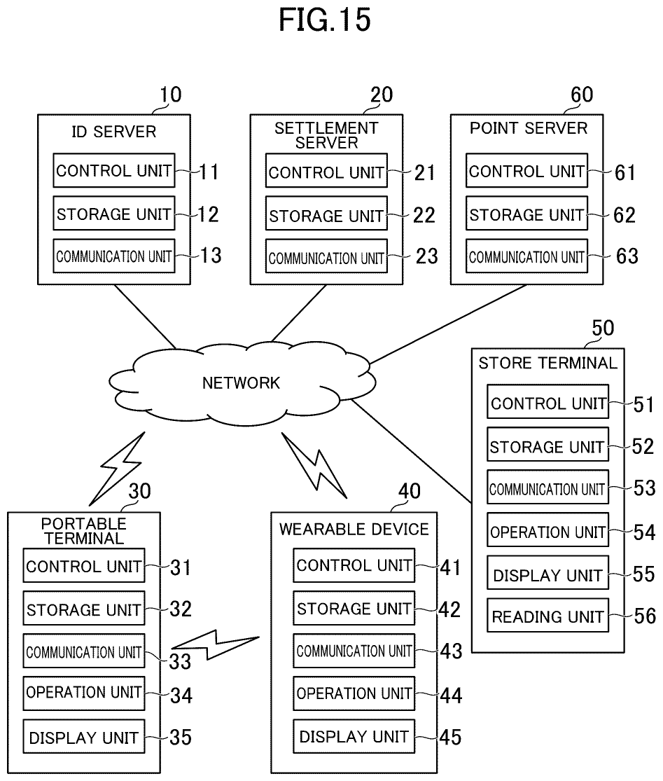

FIG. 15 is a diagram showing an example of a hardware configuration in Modification Example 1-3. As shown in FIG. 15, the settlement system 1 includes the point server 60. The point server 60 is a server computer that provides a point service to a user. The point service is a service in which the user uses points. For example, the point server 60 includes a control unit 61, a storage unit 62, and a communication unit 63. The hardware configurations of the control unit 61, the storage unit 62, and the communication unit 63 may be the same as those of the control unit 11, the storage unit 12, and the communication unit 13, respectively. An operator of the point service and an operator of the settlement service may be the same or different. When these operators are different from each other, these operators are in a cooperative relationship and can provide each other's information as appropriate.

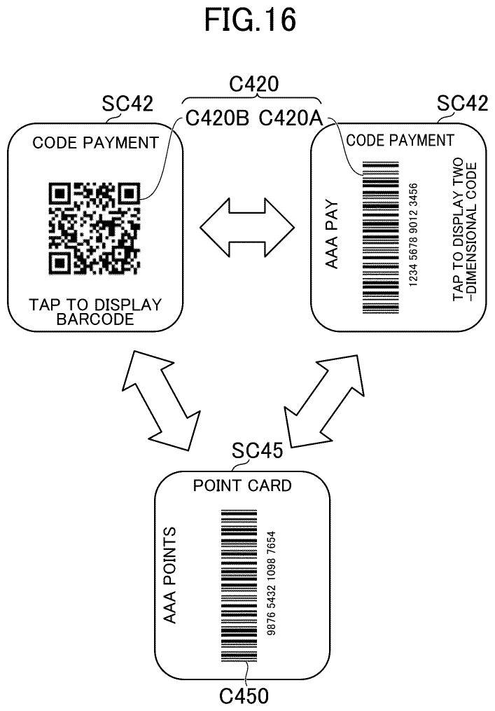

FIG. 16 is a diagram showing an example of a screen displayed on the wearable device 40 in Modification Example 1-3. The example shown in FIG. 16 differs from the example shown in FIG. 3 in that the wearable device 40 displays a point card screen SC45 including a second code C450 as a point card on the display unit 45. A user can switch between the display of the code screen SC42 and the point card screen SC45 by operating the operation unit 44 (for example, swiping). In the example shown in FIG. 16, a case where the second code C450 is a barcode is shown, but the second code C450 may be a two-dimensional code. The second code C450 may be a code for the user to not only acquire points, but also make a payment with the points that the user himself or herself owns. A flow of a process of making a payment with the points that the user himself or herself owns may be similar to the process adopted for known point cards.

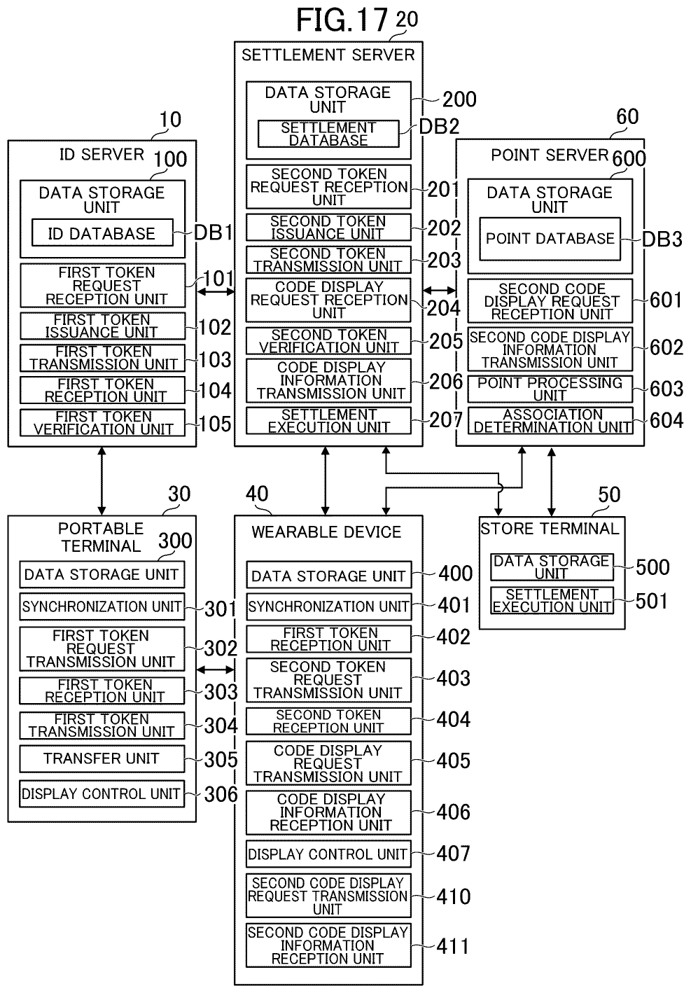

FIG. 17 is a diagram showing an example of functions implemented by the settlement system 1 in Modification Examples 1-3 to 1-6. In Modification Example 1-3, a case is exemplified in which the wearable device 40 communicates directly with the point server 60 to display the second code C450. However, the wearable device 40 may display the second code C450 by indirectly communicating with the point server 60 via the settlement server 20. In this case, a second code display request to be described later is transmitted from the wearable device 40 to the settlement server 20. The settlement server 20 may acquire second code display information from the point server 60 and transmit it to the wearable device 40.

In Modification Example 1-3, the code display request reception unit 204 described in the first embodiment is a first code display request reception unit 204 that receives a first code request for displaying the first code C420. For convenience of description, the only difference is that the code C420 in the first embodiment is described as the first code C420, and the processing of the first code display request reception unit 204 is the same as that of the code display request reception unit 204 described in the first embodiment. That is, in the description of the first code display request reception unit 204, the description of “code” can be read as “first code” in the description of the code display request reception unit 204 in the first embodiment.

In Modification Example 1-3, the code display information transmission unit 206 described in the first embodiment is a first code display information transmission unit 206 that transmits, to the wearable device 40, first code display information regarding the display of the first code C420 used in the settlement service. For convenience of description, the only difference is that the code C420 in the first embodiment is described as the first code C420, and the processing of the first code display information transmission unit 206 is the same as that of the code display information transmission unit 206 described in the first embodiment. That is, in the description of the code display information transmission unit 206 in the first embodiment, the description of “code” can be read as “first code”.

For example, the point server 60 includes a data storage unit 600, a second code display request reception unit 601, a second code display information transmission unit 602, and a point processing unit 603. The data storage unit 600 is implemented by the storage unit 62. The second code display request reception unit 601, the second code display information transmission unit 602, and the point processing unit 603 are each implemented by the control unit 61. The data storage unit 600 stores a point database DB3.

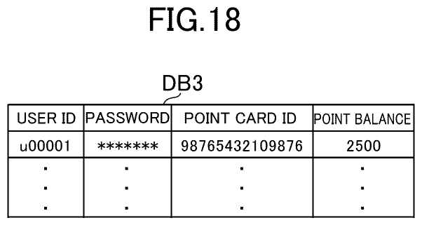

FIG. 18 is a diagram showing an example of the point database DB3. The point database DB3 is a database in which various information regarding each of a plurality of users in a point service is stored. For example, the point database DB3 stores a user ID, a password, a point card ID, and a point balance. Other information may be stored in the point database DB3. For example, the point database DB3 may store usage history information regarding a usage history of the point service. In Modification Example 1-3, a case in which a user ID of a certain user stored in the settlement database DB2 is the same as the user ID of the user stored in the point database DB3 is described, but these user IDs may be different from each other. When these user IDs are different from each other, it is assumed that a relationship database showing a relationship between the user ID stored in the settlement database DB2 and the user ID stored in the point database DB3 is stored in the data storage unit 600. The relationship database may be stored in the data storage unit 200 of the settlement server 20, in a computer other than the settlement server 20 and the point server 60, or in an external information storage medium.

The point card ID is point identification information with which points held by the user can be identified. The point identification information may be information other than the point card ID. For example, the point identification information may be a user ID. That is, user identification information in the point service may be equivalent to the point identification information. In Modification Example 1-3, a case where the point card ID is a temporary ID is exemplified, similar to the code ID. The point card ID may have a validity period.

The second code display request reception unit 601 receives a second code display request related to the display of the second code C450 from the wearable device 40. The second code display request differs from the first code display request in that the second code display request is related to the display of the second code C450, but is similar to the first code display request in other respects. That is, the second code display request is data in a predetermined format for requesting the display of the second code C420. The second code display request may be in any format and may be, for example, in a format according to the API specifications of the point server 60.

For example, the second code display request may include any information. For example, the second code display request may include a second token, a user ID, information (for example, a temporary ID) with which the user ID can be searched for, a login account, information (for example, a temporary ID) with which the login account can be searched for, a portable terminal ID, a wearable device ID, or other information.

In Modification Example 1-3, it is assumed that the second token is included in the second code display request. The point server 60 requests the settlement server 20 to verify the second token included in the second code display request. When the settlement server 20 receives a request to verify the second token, the second token verification unit 205 verifies the second token. A method of verifying the second token is as described in the first embodiment. The second token verification unit 205 transmits a verification result to the point server 60. The point server 60 receives the verification result of the second token from the settlement server 20.

For example, the second code display information transmission unit 602 transmits, to the wearable device 40, second code display information regarding the display of the second code C450 different from the first code C420. The second code display information is information used to display the code C420. In Modification Example 1-3, a case where a point card ID is equivalent to the second code display information is exemplified, but the second code display information may include information (for example, URL) other than the point card ID. The second code display information may be image data of the second code C450.

For example, the second code display information transmission unit 602 issues a point card ID based on a predetermined ID issuance rule. The ID issuance rule may be any rule. For example, the ID issuance rule may be a rule indicating that the point card ID is to be issued as random letters, numbers, symbols, or a combination thereof. The second code display information transmission unit 602 issues a point card ID so that the point card ID is not the same as other point card IDs. When a validity period is determined for the point card ID, the second code display information transmission unit 602 issues the point card ID so that the point card ID is not the same as other point card IDs within the validity period.

In Modification Example 1-3, the second code display information transmission unit 602 transmits the second code display information to the wearable device 40 when the second token included in the second code display request is verified. The second code display information transmission unit 602 transmits the second code display information to the wearable device 40 on the condition that the second token is verified. Here, the second token being verified means that the validity of the second token is confirmed. When the second token is not used, the second code display information transmission unit 602 may transmit the second code display information to the wearable device 40 on the condition that the first token is verified.

The point processing unit 603 executes a process of providing a point service to a user. The process of the point service may be similar to a known process. For example, the point processing unit 603 acquires a point card ID read from a second code C460 from the store terminal 50. The point processing unit 603 determines whether the point card ID acquired from the store terminal 50 is stored in the point database DB3. When it is determined that the point card ID acquired from the store terminal 50 is stored in the point database DB3, the point processing unit 603 executes a process for increasing a point balance associated with the point card ID on the condition that a settlement is executed. The point server 60 only needs to acquire information indicating the execution of the settlement from the settlement server 20. The point balance may be increased immediately or after a certain period of time elapses. The point processing unit 603 transmits the execution result of the process performed by the point processing unit 603 to the store terminal 50.

In Modification Example 1-3, the code display request transmission unit 405 and the code display information reception unit 406 described in the first embodiment are referred to as a first code display request transmission unit 405 and a first code display information reception unit 406, respectively. For convenience of description, the only difference is that the code C420 in the first embodiment is described as a first code C420, and the processes of the first code display request transmission unit 405 and the first code display information reception unit 406 are the same as the processes of the code display request transmission unit 405 and the code display information reception unit 406 described in the first embodiment. That is, in the description of the first code display request transmission unit 405 and the first code display information reception unit 406 in the first embodiment, the description of “code” can be read as “first code”.

The wearable device 40 in Modification Example 1-3 includes a second code display request transmission unit 410 and a second code display information reception unit 411. The second code display request transmission unit 410 and the second code display information reception unit 411 are each implemented by the control unit 41.

The second code display request transmission unit 410 transmits a second code display request to the point server 60. For example, the second code display request transmission unit 410 transmits a second code display request to the point server 60 directly or indirectly. The meanings of the terms “directly” and “indirectly” are as described above. In Modification Example 1-3, the point server 60 acquires code display information, and thus the second code display request transmission unit 410 transmits a second code display request to the point server 60. When a computer (for example, the settlement server 20) other than the point server 60 acquires second code display information, the second code display request transmission unit 410 only needs to transmit a second code display request to the other computer.

The second code display information reception unit 411 receives the second code display information from the point server 60. For example, the second code display information reception unit 411 receives the second code display information directly or indirectly from the point server 60. The meanings of the terms “directly” and “indirectly” are as described above. In Modification Example 1-3, the second code display information reception unit 411 receives the second code display information from the second code display information transmission unit 602 of the point server 60.

The display control unit 407 in Modification Example 1-3 displays the second code C450 on the display unit 45 based on the second code display information. For example, when the point card ID is equivalent to the second code display information, the display control unit 407 encodes the point card ID and generates image data of the second code C450. The display control unit 407 displays the second code C450 on the display unit 45 based on the image data. When the image data of the second code C450 is equivalent to the second code display information, the display control unit 407 displays the second code C450 on the display unit 45 based on the second code display information which is image data.

The settlement system 1 according to Modification Example 1-3 transmits the first code display information to the wearable device 40. The settlement system 1 transmits the second code display information to the wearable device 40. Thereby, the settlement system 1 can display not only the first code C420 but also the second code C450 on the wearable device 40, thereby improving user convenience.

### Modification Example 1-4

For example, in Modification Example 1-3, a case is exemplified in which the first code display information transmission unit 206 and the second code display information transmission unit 602 are implemented by separate servers, but the first code display information transmission unit 206 and the second code display information transmission unit 602 may be implemented by the same server. In Modification Example 1-4, a case is exemplified in which the first code display information transmission unit 206 and the second code display information transmission unit 602 are implemented by the settlement server 20. The first code display information transmission unit 206 of the settlement server 20 is as described in Modification Example 1-3.

For example, the second code display information transmission unit 602 of the settlement server 20 is implemented by the control unit 21. The settlement server 20 may include the second code display request reception unit 601. The second code display request reception unit 601 of the settlement server 20 is implemented by the control unit 21. When the first code display request and the second code display request are not made separately but are combined into one code display request, the code display request reception unit 204 described in the first embodiment may receive the one code display request.

For example, the second code display request reception unit 601 of the settlement server 20 receives a second code display request from the wearable device 40. This modification example differs from Modification Example 1-3 in that the wearable device 40 transmits the second code display request to the settlement server 20 instead of the point server 60, but they are the same in other respects. The second code display request reception unit 601 of the settlement server 20 may receive the second code display request directly or indirectly from the wearable device 40.

For example, the second code display information transmission unit 602 of the settlement server 20 transmits the second code display information to the wearable device 40. The settlement server 20 may request the point server 60 to generate the second code display information. In this case, the point server 60 acquires the second code display information based on the request from the settlement server 20 and transmits it to the settlement server 20. The settlement server 20 receives the second code display information from the point server 60. The second code display information transmission unit 602 of the settlement server 20 transmits the second code display information received from the point server 60 to the wearable device 40.

In addition, the settlement server 20 may generate the second code display information by itself, instead of requesting the point server 60 to generate the second code display information. In this case, the settlement server 20 may store the point database DB3. The second code display information transmission unit 602 of the settlement server 20 transmits the second code display information generated by the settlement server 20 to the wearable device 40. In addition, the first code display information transmission unit 206 and the second code display information transmission unit 602 may transmit the first code display information and the second code display information to the wearable device 40 all at once, rather than transmitting them separately.

In the settlement system 1 according to Modification Example 1-4, the first code display information transmission unit 206 and the second code display information transmission unit 602 are implemented by the same server. Thereby, the function of transmitting the first code display information and the function of transmitting the second code display information can be integrated into the same server, making it possible to simplify the configuration of the settlement system 1. For example, the settlement system 1 can also transmit the first code display information and the second code display information together at once. The wearable device 40 does not need to acquire the first code display information and the second code display information from separate servers.

### Modification Example 1-5

For example, even when a user uses a settlement service, the user may not hold a point card (not use a point service). In this case, the processes in Modification Examples 1-3 and 1-4 may be executed only for a user who holds a point card. The point server 60 in Modification Example 1-5 includes an association determination unit 604. The association determination unit 604 is implemented by the control unit 61. The association determination unit 604 determines whether information regarding the second code C450 is associated with the user. In Modification Example 1-5, the information regarding the second code C450 is a user ID in the point database DB3, or various information (for example, a point balance) associated with the user ID. For users who do not hold a point card, this information is not stored in the point database DB3.

In Modification Example 1-5, as in Modification Example 1-3, a case where the second code display information transmission unit 602 is implemented by the point server 60 is exemplified. For example, when the point server 60 receives a second code display request, the association determination unit 604 specifies the user ID of the user of the wearable device 40 that transmitted the second code display request, and determines whether the user ID is stored in the point database DB3. When the association determination unit 604 determines that the user ID is stored in the point database DB3, the association determination unit 604 determines that information regarding the second code C450 is associated with the user. When the association determination unit 604 determines that the user ID is not stored in the point database DB3, the association determination unit 604 determines that information regarding the second code C450 is not associated with the user.

The second code display information transmission unit 602 in Modification Example 1-5 transmits the second code display information to the wearable device 40 based on the determination result of the association determination unit 604. For example, when the second code display information transmission unit 602 determines that the information on the second code C450 is not associated with the user, the second code display information transmission unit 602 does not transmit the second code display information to the wearable device 40, and when the second code display information transmission unit 602 determines that the information on the second code C450 is associated with the user, the second code display information transmission unit 602 transmits the second code display information to the wearable device 40. When Modification Examples 1˜4 and 1-5 are combined, the association determination unit 604 may be implemented by the settlement server 20.

The settlement system 1 according to Modification Example 1-5 determines whether the information related to the second code C450 is associated with the user. The settlement system 1 transmits the second code display information to the wearable device 40 based on the execution result of the determination. Thereby, the settlement system 1 can prevent the second code C450 from being displayed on the wearable device 40 of a user who does not need the second code C450 (the wearable device 40 of a user who does not hold a point card).

### Modification Example 1-6

For example, as in Modification Examples 1-3 to 1-5, the first code C420 may be a code for a user to perform a settlement. The second code C450 may be a code for the user to obtain a privilege in the settlement. In Modification Examples 1-3 to 1-5, points are described as an example of a privilege, but the privilege is not limited to points. For example, the privilege may be a discount obtained by using a coupon, or a product or service obtained by using a coupon. A process required to display each of the first code C420 and the second code C450 may be the same as in Modification Examples 1-3 to 1-5.

When one of the first code C420 and the second code C450 is read, the display control unit 407 in Modification Example 1-6 displays the other of the first code C420 and the second code C450. For example, when the first code C420 is read, the display control unit 407 displays the second code C450. When the first code C420 is read by the store terminal 50, the process described in the first embodiment is executed, and the settlement server 20 notifies the wearable device 40 that the first code C420 is read. The wearable device 40 may detect that the first code C420 is read by the notification given from the settlement server 20. When the display control unit 407 receives the notification, the display control unit 407 displays the second code C450.

For example, the display control unit 407 may display the first code C420 when the second code C450 is read. When the second code C450 is read by the store terminal 50, the point server 60 notifies the wearable device 40 that the second code C450 is read. The wearable device 40 may detect that the second code C450 is read by the notification given from the point server 60. When the display control unit 407 receives the notification, the display control unit 407 displays the first code C420.

In the settlement system 1 according to Modification Example 1-6, the first code C420 is a code for the user to perform a settlement. The second code C450 is a code for the user to acquire a privilege in the settlement. When one of the first code C420 and the second code C450 is read, the settlement system 1 displays the other of the first code C420 and the second code C450. Thereby, the user does not need to perform an operation of switching between the display of the first code C420 and the display of the second code C450, and thus the settlement system 1 can improve user convenience.

### Modification Example 1-7

For example, the portable terminal 30 may be connectable to a plurality of wearable devices 40. In Modification Example 1-7, a plurality of wearable devices 40 are paired with one portable terminal 30. The plurality of wearable devices 40 may be paired with the portable terminal 30 at the same time, or may be paired separately without being paired with the portable terminal 30 at the same time. The portable terminal 30 is synchronized with each of the plurality of wearable devices 40. The process in which each wearable device 40 is synchronized with the portable terminal 30 may be the same as in the first embodiment. Each wearable device 40 may have the same functions as in the first embodiment and Modification Examples 1-1 to 1-6.

For example, each of the plurality of wearable devices 40 may store a second token issued for the wearable device 40 based on a first token common to the plurality of wearable devices 40. Each wearable device 40 has the function described in the first embodiment. A second token issued for a certain wearable device 40 is different from a second token issued for another wearable device 40. However, the first token is common to these wearable devices 40.

The code display request reception unit 204 in Modification Example 1-7 receives, from each of the plurality of wearable devices 40, a code display request including a second token stored in the wearable device 40. The code display information transmission unit 206 transmits code display information to the wearable device 40 when the second token included in the code display request received from each of the plurality of wearable devices 40 is verified. This series of processes may be the same as the processes described in the first embodiment and Modification Examples 1-1 to 1-6.

In the settlement database DB2 in Modification Example 1-7, a wearable device ID of each of the wearable devices 40 connected to a certain portable terminal 30 is stored in association with a second token. When the second token verification unit 205 verifies a second token received from a certain wearable device 40, the second token verification unit 205 may perform the verification based on the second token stored in the settlement database DB2 in association with the wearable device ID of the wearable device 40 and the second token received from the wearable device 40.

In the settlement system 1 according to Modification Example 1-7, each of the plurality of wearable devices 40 stores a second token issued for that wearable device 40, the second token being issued based on a first token common to the plurality of wearable devices 40. The settlement system 1 receives a code display request including the second token stored in the wearable device 40 from each of the plurality of wearable devices 40. When the second token included in the code display request received from each of the plurality of wearable devices 40 is verified, the settlement system 1 transmits code display information to the wearable device 40. Thereby, the user can use a settlement service from the plurality of wearable devices 40, and thus the settlement system 1 can improve user convenience. Furthermore, since different second tokens can be issued to the plurality of wearable devices 40 with a common first token, the settlement system 1 can simplify the management of the first token.

### 3-2. Modification Example of Second Embodiment

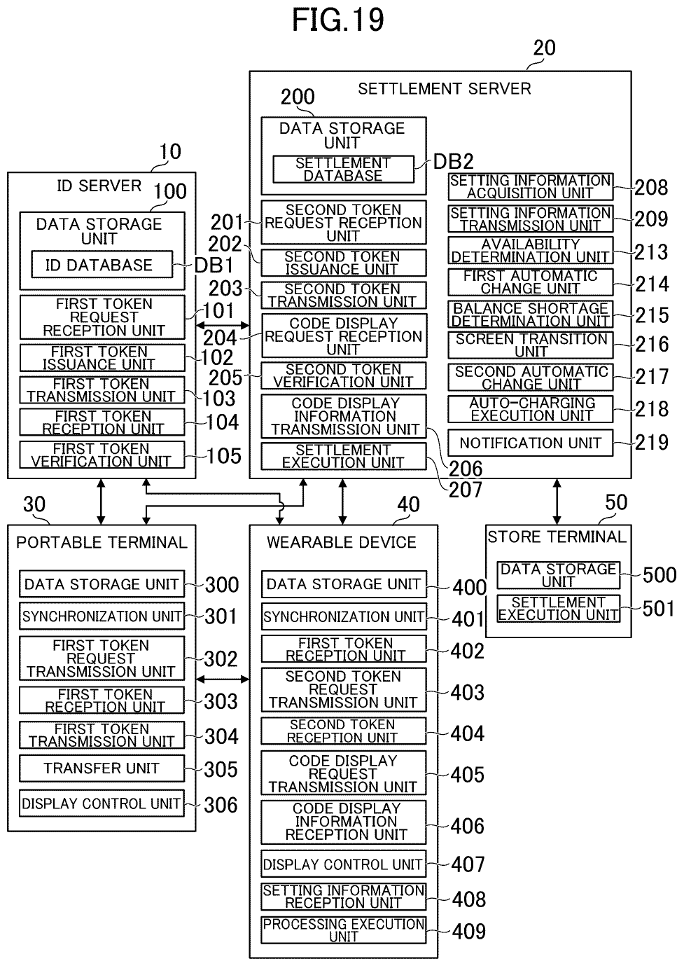

FIG. 19 is a diagram showing an example of functions implemented in Modification Examples 2-1 to 2-7. For example, in Modification Examples 2-1 to 2-7, the settlement server 20 includes an availability determination unit 213, first automatic change unit 214, a balance shortage determination unit 215, a screen transition unit 216, a second automatic change unit 217, and a notification unit 219. Each of the availability determination unit 213, the first automatic change unit 214, the balance shortage determination unit 215, the screen transition unit 216, the second automatic change unit 217, an auto-charging execution unit 218, and the notification unit 219 is implemented by the control unit 21.

### Modification Example 2-1

For example, in the second embodiment, a case is exemplified in which setting information indicates settings related to a payment source in a settlement service. The wearable device 40 may have no restrictions on a payment source, or may cope with only some payment sources. In Modification Example 2-1, a case is exemplified in which a settlement cannot be performed using a bank account as a payment source in a settlement from the wearable device 40. In this case, the availability of the payment source may be determined depending on whether the payment source set by the user is a bank account.

The settlement system 1 according to Modification Example 2-1 includes the availability determination unit 213. The availability determination unit 213 determines whether the payment source indicated by the setting information is available on the wearable device 40. Availability data indicating payment sources available on the wearable device 40 is assumed to be stored in the data storage unit 200. The availability data may be in any format. For example, the availability data may be in a table format, in a mathematical formula format, a part of a program, a machine learning model, or in other formats. The available payment sources may be determined for each user. In Modification Example 2-1, the availability data indicates that a bank account is not available as a payment source.

For example, the availability determination unit 213 determines whether the current payment source is available on the wearable device 40 based on the setting information stored in the settlement database DB2 and the availability data. When the current payment source indicated by the setting information is not a bank account, the availability determination unit 213 determines that the payment source is available on the wearable device 40. When the current payment source indicated by the setting information is a bank account, the availability determination unit 213 determines that the payment source is not available on the wearable device 40.

The setting information transmission unit 209 in Modification Example 2-1 transmits setting information to the wearable device 40 based on the determination result of the availability determination unit 213. For example, when the setting information transmission unit 209 determines that the payment source is available on the wearable device 40, the setting information transmission unit 209 transmits setting information to the wearable device 40. When the setting information transmission unit 209 determines that the payment source is not available on the wearable device 40, the setting information transmission unit 209 may notify the wearable device 40 of an error or may give a notification to prompt the user to change the payment source without transmitting the setting information.

The settlement system 1 according to Modification Example 2-1 determines whether the payment source indicated by the setting information is available on the wearable device 40. The settlement system 1 transmits the setting information to the wearable device 40 based on the result of the determination. Thereby, the settlement system 1 can reliably perform settlement using a payment source that is available on the wearable device 40.

### Modification Example 2-2

For example, in Modification Example 2-1, automatic change of a payment source may be performed. The settlement system 1 according to Modification Example 2-2 includes the first automatic change unit 214. The first automatic change unit 214 automatically changes a payment source when it is determined that the payment source indicated by the setting information is not available on the wearable device 40. For example, the first automatic change unit 214 specifies a plurality of settlement means that can be used by the user, based on settlement means information stored in the settlement database DB2. The first automatic change unit 214 updates the setting information so that any one settlement means that is available on the wearable device 40 among the specified plurality of settlement means is set as a payment source. The updated setting information may be transmitted to the wearable device 40.

The settlement system 1 according to Modification Example 2-2 automatically changes a payment source when it is determined that the payment source indicated by the setting information is not available on the wearable device 40. Thereby, the user does not need to perform an operation of changing a payment source, and thus the settlement system 1 can improve user convenience.

### Modification Example 2-3

For example, when the user attempts to perform a settlement from the wearable device 40, the balance of electronic money or points set as a payment source may be insufficient. In this case, the wearable device 40 may automatically transition to a screen for using other settlement means.

The settlement system 1 according to Modification Example 2-3 includes the balance shortage determination unit 215 and the screen transition unit 216. The balance shortage determination unit 215 determines whether the balance of a settlement means used by the user in a settlement service is insufficient. In Modification Example 2-3, a case where the user performs a payment with points is exemplified. The settlement server 20 in Modification Example 2-3 can inquire about points from the point server 60 described in Modification Example 1-3. For example, the balance shortage determination unit 215 acquires the balance of points from the point server 60. The balance shortage determination unit 215 acquires a settlement amount from the store terminal 50. The balance shortage determination unit 215 determines whether the balance is insufficient by determining whether the settlement amount is more than the balance.

The user may make a payment with electronic money. The balance of the electronic money may be stored in the settlement database DB2 or may be stored in a database other than the settlement database DB2. The balance of the electronic money may be stored in a computer other than the settlement server 20 or in an external information storage medium. The balance shortage determination unit 215 may acquire the balance of the electronic money from the settlement database DB2, another database, another computer, or an external information storage medium and perform determination.

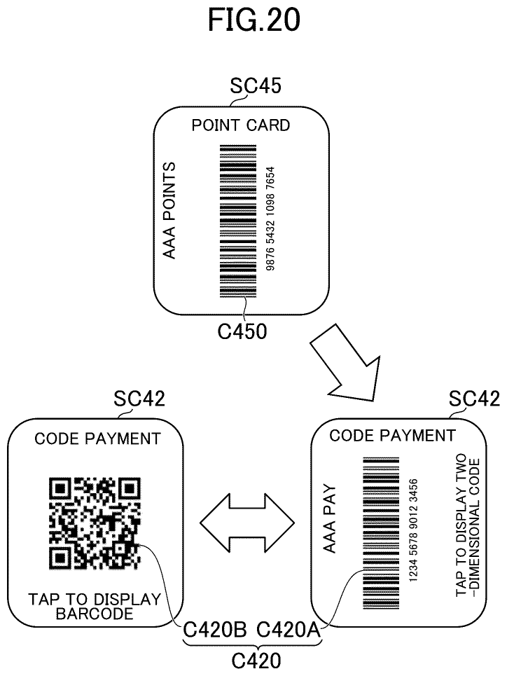

FIG. 20 is a diagram showing an example of a screen transition of the wearable device 40 in Modification Example 2-3. When it is determined that the balance is insufficient, the screen transition unit 216 makes the screen of the wearable device 40 transition to a screen for the user to use a settlement means other than the settlement means. For example, when the point balance is insufficient, the screen transition unit 216 transitions from the point card screen SC45 to the code screen SC42.

For example, the screen transition unit 216 may perform a screen transition from the point card screen SC45 to the code screen SC42 by transmitting an instruction for a screen transition to the wearable device 40. The instruction may include code display information. The wearable device 40 performs a screen transition based on an instruction from the settlement server 20. A method in which the wearable device 40 displays the code screen SC42 may be the same as in the first or second embodiment. A method in which the wearable device 40 displays the point card screen SC45 may be the same as in Modification Examples 1-3 to 1-6.

The settlement system 1 according to Modification Example 2-3 determines whether the balance of the settlement means used by the user in the settlement service is insufficient. When the settlement system 1 determines that the balance is insufficient, the settlement system 1 makes the screen of the wearable device 40 transition to a screen for the user to use another settlement means different from the settlement means. Thereby, the user does not need to perform an operation for transitioning to the screen of the other settlement means, and thus the settlement system 1 can improve user convenience.

### Modification Example 2-4

For example, in Modification Example 2-3, a case where a screen transition is performed based on a determination result of an insufficient balance is described, but a payment source may be automatically changed based on a determination result of the insufficient balance. The settlement system 1 according to Modification Example 2-4 includes the balance shortage determination unit 215 and the second automatic change unit 217. The balance shortage determination unit 215 may be the same as in Modification Example 2-3.

When it is determined that the balance of a certain settlement means is insufficient, the second automatic change unit 217 automatically changes a payment source to another settlement means different from the settlement means. For example, the second automatic change unit 217 specifies a plurality of settlement means that can be used by the user based on the settlement means information stored in the settlement database DB2. The second automatic change unit 217 updates the setting information so that any one settlement means that is available on the wearable device 40 among the specified plurality of settlement means is set as a payment source. The updated setting information may be transmitted to the wearable device 40.

For example, the second automatic change unit 217 may automatically change a payment source to a credit card registered by the user when it is determined that the balance of points is insufficient. A flow of the settlement after the payment source is automatically changed may be the same as a known flow. After the payment source is changed, reading of the code C420 may be requested again, but in Modification Example 2-4, it is assumed that the settlement is automatically executed based on the changed payment source without reading the code C420 again.

The settlement system 1 according to Modification Example 2-4 determines whether the balance of the settlement means used by the user in the settlement service is insufficient. When it is determined that the balance is insufficient, the settlement system 1 automatically changes the payment source to another settlement means different from the settlement means. Thereby, the user does not need to perform an operation of changing the payment source, and thus the settlement system 1 can improve user convenience.

### Modification Example 2-5

For example, in Modification Example 2-3, a case where a screen transition is performed based on a determination result of an insufficient balance is described, and in Modification Example 2-4, a case where a payment source is automatically changed based on a determination result of an insufficient balance is described. However, a settlement means may be auto-charged based on a determination result of a balance. The settlement system 1 according to Modification Example 2-5 includes the balance shortage determination unit 215 and the auto-charging execution unit 218. The balance shortage determination unit 215 may be the same as in Modification Example 2-3 and 2-4, but in Modification Example 2-5, it is assumed that a settlement means is electronic money. As described in Modification Example 2-3, a payment may be performed with electronic money.

When it is determined that the balance is insufficient, the auto-charging execution unit 218 executes auto-charging of the settlement means based on an insufficient amount of the balance. The auto-charging execution unit 218 calculates the insufficient amount based on a difference between a settlement amount and the balance of electronic money. The auto-charging execution unit 218 may determine the insufficient amount as a charge amount as it is, or may determine a value obtained by adding a predetermined numerical value to the insufficient amount to be the charge amount. The auto-charging execution unit 218 executes auto-charging based on the determined charge amount. Charging may be executed by a known method. For example, the auto-charging execution unit 218 executes a settlement by the charge amount based on a charge source designated in advance by the user, and executes a process of increasing the balance of the settlement means. After the auto-charging is executed, the settlement is executed.

When it is determined that the balance is insufficient, the settlement system 1 according to Modification Example 2-5 executes auto-charging of the settlement means based on the insufficient amount of the balance. Thereby, the user does not need to instruct charging when a balance is insufficient in a settlement using the wearable device 40, and the settlement system 1 can improve user convenience.

### Modification Example 2-6

For example, the display control unit 306 of the portable terminal 30 may display information regarding the wearable device 40 on the portable terminal 30. In the example shown in FIG. 2, when the user selects a button B304 to execute synchronization, the display control unit 306 may display the name and wearable device ID of the wearable device 40 synchronized with the portable terminal 30 on the code screen SC30 or another screen. It is assumed that the portable terminal 30 acquires the name and wearable device ID of the wearable device 40 from the wearable device 40 at the time of synchronization.

The settlement system 1 according to Modification Example 2-6 displays information regarding the wearable device 40 on the portable terminal 30. Thereby, the user can confirm the information regarding the wearable device 40 on the portable terminal 30, and thus the settlement system 1 can improve user convenience.

### Modification Example 2-7

For example, in Modification Example 2-1, a case is exemplified in which a restriction is imposed on a settlement means that is available on the wearable device 40. When a payment source set by the user is not available on the wearable device 40, the portable terminal 30 may notify the user of that effect. The notification may be given through a screen of a portable terminal application, a notification function of the portable terminal application, a push notification, a banner notification, a pop-up notification, or other methods.

The settlement system 1 according to Modification Example 2-7 includes the availability determination unit 213 and the notification unit 219. When a setting is designated on the portable terminal 30, the availability determination unit 213 determines whether the setting is available on the wearable device 40. This modification example differs from Modification Example 2-1 in that availability is determined at a timing when a setting is designated on the portable terminal 30, but a method of determining the availability may be the same as in Modification Example 2-1.

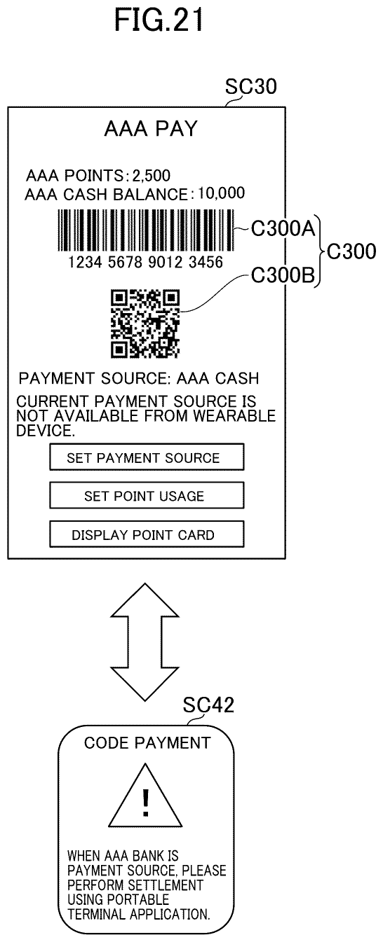

FIG. 21 is a diagram showing an example of a screen displayed on the portable terminal 30 in Modification Example 2-7. The notification unit 219 notifies the user of a determination result of the availability determination unit 213. As shown in the upper part of FIG. 21, when the user designates a setting that is not available on the wearable device 40, the notification unit 219 notifies the user of that effect. When the user designates a setting that is available on the wearable device 40, the notification unit 219 notifies the user of that effect.

For example, the notification unit 219 transmits a notification including information indicating a determination result obtained by the availability determination unit 213 (in the example shown in the upper part of FIG. 21, a message “The current payment source is not available on a wearable device.”) to the portable terminal 30. The portable terminal 30 displays the code screen SC30 based on the notification. The determination result obtained by the availability determination unit 213 may be notified using an image such as an icon in addition to a message. As shown in the lower part of FIG. 21, the wearable device 40 may display a message indicating that the current payment source is not available on the code screen SC42. In this case, the code C420 may not be displayed.

When a setting is designated on the portable terminal 30, the settlement system 1 according to the Modification Example 2-7 determines whether the setting is available on the wearable device 40. The settlement system 1 notifies the user of the execution result of the determination. Thereby, the user can know whether the setting that the user attempts to designate on the portable terminal 30 is available on the wearable device 40, and thus the settlement system 1 can improve user convenience.

### 3-3. Other Modification Examples

For example, at least two of the first embodiment, the second embodiment, Modification Examples 1-1 to 1-7, and Modification Examples 2-1 to 2-7 may be combined.

For example, the functions described as being implemented by the ID server 10 may be implemented by the settlement server 20, the portable terminal 30, the wearable device 40, or another computer. The processes described as being implemented by the settlement server 20 may be implemented by the ID server 10, the portable terminal 30, the wearable device 40, or another computer. The processes described as being implemented by the portable terminal 30 may be implemented by the ID server 10, the settlement server 20, the wearable device 40, or another computer. The processes described as being implemented by the wearable device 40 may be implemented by the ID server 10, the settlement server 20, the portable terminal 30, or another computer. The processes described as being implemented by the ID server 10, the settlement server 20, the portable terminal 30, the wearable device 40, or another computer may be shared by a plurality of computers.

What is claimed is:

1. A settlement system comprising at least one processor that acquires setting information regarding settings related to a settlement service, the settings being designated on a user's portable terminal in the settlement service, and transmits the setting information to a wearable device that is connectable to the portable terminal.

2. The system according to claim 1, wherein the at least one processor
receives a code display request including user identification information with which the user is identifiable, the code display request being related to display of a code used in the settlement service, and
acquires the setting information based on the user identification information included in the code display request.

3. The system according to claim 2, wherein the at least one processor transmits the setting information and code display information related to the display of the code to the wearable device.

4. The system according to claim 1, wherein
the setting information indicates settings related to a payment source in the settlement service, and
the at least one processor determines whether the payment source indicated by the setting information is available on the wearable device, and transmits the setting information to the wearable device based on a determination result.

5. The system according to claim 4, wherein the at least one processor automatically changes the payment source when it is determined that the payment source indicated by the setting information is not available on the wearable device.

6. The system according to claim 1, wherein the at least one processor
determines whether a balance of a settlement means used by the user in the settlement service is insufficient, and
makes a screen of the wearable device transition to a screen for the user to use another settlement means other than the settlement means when it is determined that the balance is insufficient.

7. The system according to claim 1, wherein the at least one processor
determines whether the balance of the settlement means used by the user in the settlement service is insufficient, and
automatically changes a payment source to another settlement means different from the settlement means when it is determined that the balance is insufficient.

8. The system according to claim 1, wherein the at least one processor
determines whether a balance of a settlement means used by the user in the settlement service is insufficient, and
executes auto-charging of the settlement means based on an insufficient amount of the balance when it is determined that the balance is insufficient.

9. The system according to claim 1, wherein the at least one processor causes the portable terminal to display information regarding the wearable device.

10. The system according to claim 1, wherein the at least one processor
determines whether the settings are available on the wearable device when the settings are designated on the portable terminal, and
notifies the user of a determination result.

11. A processing execution method comprising:
transmitting a predetermined request by a wearable device that is connectable to a portable terminal of a user in a settlement service;
acquiring setting information regarding settings related to the settlement service when the request is received, the settings being designated on the portable terminal;
transmitting the setting information to the wearable device that is connectable to the portable terminal;
receiving the setting information regarding the settings; and
executing processing related to the settlement service based on the setting information.

12. A non-transitory information storage medium storing a program causing a computer to:
acquire setting information regarding settings related to a settlement service, the settings being designated on a user's portable terminal in the settlement service; and
transmit the setting information to a wearable device that is connectable to the portable terminal.
